(19) United States
(12) Patent Application Publication
(10) Pub. No.: US 2014/0112476 A1
(43) Pub. Date: Apr. 24, 2014

(54) INTEGRATED CIRCUIT, WIRELESS COMMUNICATION APPARATUS, AND COMPUTER PROGRAM

(71) Applicant: Sony Corporation, Tokyo (JP)

(72) Inventor: Katsuyuki Teruyama, Tokyo (JP)

(73) Assignee: SONY CORPORATION, Tokyo (JP)

(21) Appl. No.: 14/056,395

(22) Filed: Oct. 17, 2013

(30) Foreign Application Priority Data
Oct. 24, 2012 (JP) 2012-235155

(51) Int. Cl. H04W 12/08

(52) U.S. Cl. CPC H04W 12/08
USPC 380/270

(57) ABSTRACT

There is provided an integrated circuit including a communication processing section which communicates with another apparatus by non-contact communication capable of executing simultaneous communication by establishing a plurality of connections, and an encryption processing section which executes an encryption process of data transmitted by the non-contact communication based on encryption information including connections to be encrypted when performing the non-contact communication with the another apparatus.

### CROSS REFERENCE TO RELATED APPLICATIONS

This application claims the benefit of Japanese Priority Patent Application JP 2012-235155 filed Oct. 24, 2012, the entire contents of which are incorporated herein by reference.

### BACKGROUND

The present disclosure relates to an integrated circuit, a wireless communication apparatus, and a computer program.

Near field wireless communication systems, which perform wireless communication in a non-contact manner at a close distance, have been widely used by using IC (Integrated Circuit) cards. Such near field wireless communication systems are well known for use as electronic tickets or electronic money, for example. Further, mobile phones, which include a function of electronic tickets or electronic money by near field non-contact wireless communication, have also become widespread in recent years.

Near field wireless communication systems have spread rapidly on a global scale, and have also become international standards. For example, ISO/IEC 14443, which is a standard of proximity IC card systems, and ISO/IEC 18092, which is a standard of NFCIP (Near Field Communication Interface and Protocol)-1, are included in the international standards of near field wireless communication systems. Further, it is possible for an LLC PDU (Protocol Data Unit) defined in an NFC LLCP (NFC Forum Logical Link Control Protocol, refer to NFC Forum Logical Link Control Protocol TS 1.1), which is an upper layer protocol of ISO/IEC 18092 transport protocol, to simultaneously communicate with a plurality of connections.

### SUMMARY

When encrypting an LLC SDU (Service Data Unit), which is data of the upper layer of an LLC PDU, by using a secure channel service (NFC-SEC SCH) defined by NFC-SEC which is a security option for NFCIP-1, the entire LLC PDU is encrypted. Therefore, when performing encryption by using an NFC-SEC SCH, a process is not able to be implemented in which only some of the connections on the LLC perform communication where encryption is not necessary, and a simultaneous communication function with a plurality of connections of the LLCP is not able to be sufficiently utilized.

Accordingly, the present disclosure provides a new and improved integrated circuit, a wireless communication apparatus, and a computer program capable of selecting connections or layers to be encrypted, when performing near field non-contact wireless communication which has a simultaneous communication function with a plurality of connections.

According to an embodiment of the present disclosure, there is provided an integrated circuit including a communication processing section which communicates with another apparatus by non-contact communication capable of executing simultaneous communication by establishing a plurality of connections, and an encryption processing section which executes an encryption process of data transmitted by the non-contact communication based on encryption information including connections to be encrypted when performing the non-contact communication with the another apparatus.

Further, according to an embodiment of the present disclosure, there is provided a communication apparatus including a communication processing section which communicates with another apparatus by non-contact communication capable of executing simultaneous communication by establishing a plurality of connections, an encryption system determination section which determines the connections to be encrypted when performing the non-contact communication with the another apparatus, and an encryption processing section which executes an encryption process of data transmitted by the non-contact communication based on a determination of the encryption system determination section.

Further, according to an embodiment of the present disclosure, there is provided a communication method including a communication processing process which communicates with another apparatus by non-contact communication capable of executing simultaneous communication by establishing a plurality of connections. The communication processing process includes determining the connections to be encrypted when performing the non-contact communication with the another apparatus, and executing an encryption process of data transmitted by the non-contact communication based on a determination of the encryption system determination process.

Further, according to an embodiment of the present disclosure, there is provided a computer program for causing a computer to execute a communication processing process which communicates with another apparatus by non-contact communication capable of executing simultaneous communication by establishing a plurality of connections. The communication processing process includes determining the connections to be encrypted when performing the non-contact communication with the another apparatus, and executing an encryption process of data transmitted by the non-contact communication based on a determination of the encryption system determination process.

According to the above described present disclosure, a new and improved integrated circuit, a wireless communication apparatus, and a computer program can be provided capable of selecting connections or layers to be encrypted, when performing near field non-contact wireless communication which has a simultaneous communication function with a plurality of connections.

### BRIEF DESCRIPTION OF THE DRAWINGS

FIG. 1 is an explanatory diagram which shows a configuration example of a near field wireless communication system 1 according to an embodiment of the present disclosure;

FIG. 2 is an explanatory diagram which shows a functional configuration example of a communication apparatus 100 according to an embodiment of the present disclosure;

FIG. 3 is an explanatory diagram which shows a structure of a command ATR_REQ;

FIG. 4 is an explanatory diagram which shows a structure of a command ATR_RES;

FIG. 5 is an explanatory diagram which shows a structure of a command DEP_REQ and a command DEP_RES;

FIG. 6 is an explanatory diagram which shows a structure of a protocol data unit of NFC-SEC;

FIG. 7 is an explanatory diagram which shows a correlation between a code stored in the SEP field and the contents shown by this code;

FIG. 8 is a flow chart which shows an encryption key generation process by NFC-SEC;

FIG. 9 is a flow chart which shows an encryption communication process by NFC-SEC;

FIG. 10 is an explanatory diagram which shows a structure of a command ATR_REQ and LLC parameters;

FIG. 11 is an explanatory diagram which shows a structure of a command ATR_RES and LLC parameters;

FIG. 12 is an explanatory diagram which shows a structure of an LLC PDU;

FIG. 13 is an explanatory diagram which shows the range protected by NFC-SEC SCH;

FIG. 14 is an explanatory diagram which shows the range protected by NFC-SEC SSE;

FIG. 15 is a flow chart which shows an operation example of the communication apparatus 100 according to an embodiment of the present disclosure;

FIG. 16 is a flow chart which shows an operation example of the communication apparatus 200 according to an embodiment of the present disclosure;

FIG. 17 is a flow chart which shows an operation example of the communication apparatus 100 according to an embodiment of the present disclosure;

FIG. 18 is a flow chart which shows an operation example of the communication apparatus 100 according to an embodiment of the present disclosure;

FIG. 19 is a flow chart which shows an operation example of the communication apparatus 200 according to an embodiment of the present disclosure;

FIG. 20 is a flow chart which shows an operation example of the communication apparatus 100 according to an embodiment of the present disclosure;

FIG. 21 is a flow chart which shows an operation example of the communication apparatus 200 according to an embodiment of the present disclosure;

FIG. 22 is a flow chart which shows an operation example of the communication apparatus 100 according to an embodiment of the present disclosure;

FIG. 23 is a flow chart which shows an operation example of the communication apparatus 200 according to an embodiment of the present disclosure;

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The description will be given in the following order.

<1. An embodiment of the present disclosure>

[System configuration example]

[Functional configuration example of the communication apparatus]

[Examples of the protocol data unit]

[Operation sequence examples]

[Operation examples of the communication apparatus]

[Example of data managed by the communication apparatus]

<2. Conclusion>

### 1. AN EMBODIMENT OF THE PRESENT DISCLOSURE

### [System Configuration Example]

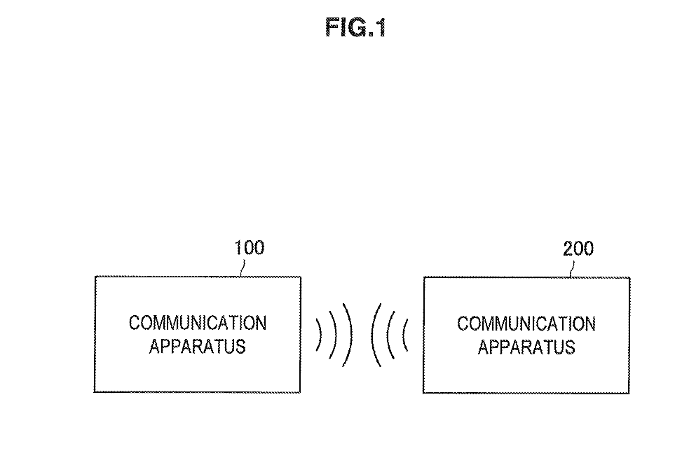

First, a configuration example of a near field wireless communication system according to an embodiment of the present disclosure will be described. FIG. 1 is an explanatory diagram which shows a configuration example of a near field wireless communication system 1 according to an embodiment of the present disclosure. Hereinafter, a configuration example of a near field wireless communication system according to an embodiment of the present disclosure will be described by using FIG. 1.

As shown in FIG. 1, the near field wireless communication system 1 according to an embodiment of the present disclosure is constituted of communication apparatuses 100 and 200. The communication apparatuses 100 and 200 are both communication apparatuses which perform near field wireless communication by one or both of ISO/IEC 18092 and ISO/IEC 14443. Further, the communication apparatuses 100 and 200 are both communication apparatuses which perform near field wireless communication by LLCP, which is an upper layer protocol of an ISO/IEC 18092 transport protocol.

The communication apparatuses 100 and 200 can both operate as either a polling device or a listening device. The polling device forms a so-called RF (Radio Frequency) field (magnetic field) by generating electromagnetic waves, transmits a polling command for detecting the listening device as a remote target, and waits for a response from the listening device. That is, the polling device performs the operations of a PCD (Proximity Coupling Device) of ISO/IEC 14443, or the operations of an initiator for a passive mode of ISO/IEC 18092.

When the listening device receives the polling command which the polling device transmits by forming an RF field, the listening device responds by a polling response. That is, the listening device performs the operations of a PICC of ISO/IEC 14443, or the operations of a target of ISO/IEC 18092. Therefore, the communication apparatuses 100 and 200 can be set with the same hardware configuration.

In the description hereinafter, these configurations and operations will be described by taking up the communication apparatus 100. Further, the operations of the communication apparatus 200 will be additionally described as necessary when describing the operations of the communication apparatus 100.

Heretofore, a configuration example of a near field wireless communication system according to an embodiment of the present disclosure has been described by using FIG. 1. Next, a functional configuration example of the communication apparatus 100 according to an embodiment of the present disclosure will be described.

### [Functional Configuration Example of the Communication Apparatus]

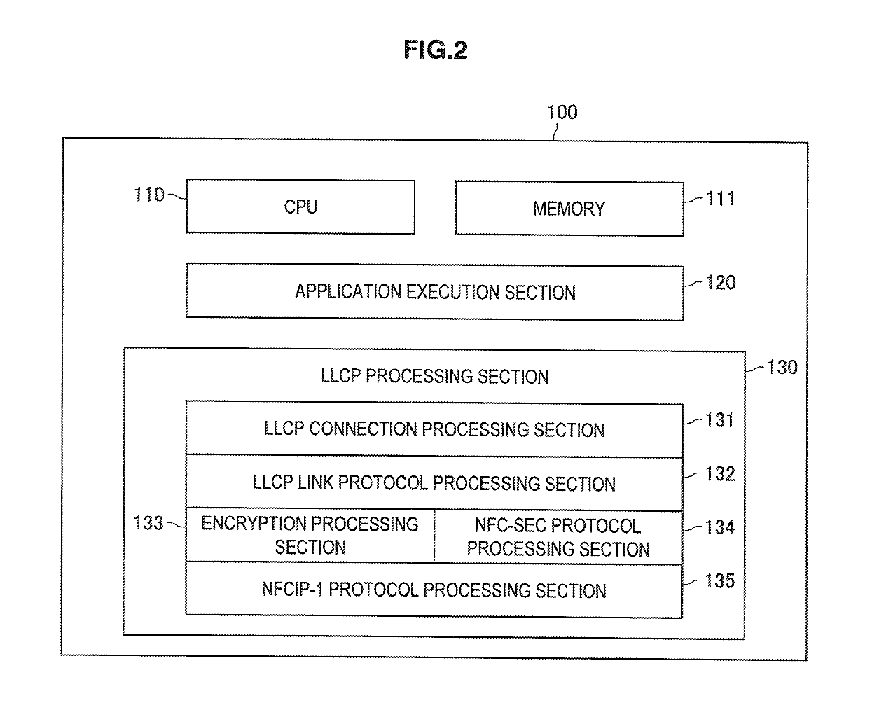

FIG. 2 is an explanatory diagram which shows a functional configuration example of the communication apparatus 100 according to an embodiment of the present disclosure. Hereinafter, a functional configuration example of the communication apparatus 100 according to an embodiment of the present disclosure will be described by using FIG. 2.

As shown in FIG. 2, the communication apparatus 100 according to an embodiment of the present disclosure is constituted of a CPU (Central Processing Unit) 110, a memory 111, an application execution section 120, and an LLCP processing section 130.

Further, such as shown in FIG. 2, the LLCP processing section 130 is constituted of an LLCP connection processing section 131, an LLCP link protocol processing section 132, an encryption processing section 133, an NFC-SEC protocol processing section 134, and an NFCIP-1 protocol processing section 135.

The CPU 110 controls the operations of the communication apparatus 100. For example, the CPU 110 may control the operations of the communication apparatus 100 by reading and sequentially executing computer programs stored in the memory 111. Further, the memory 111 is a storage region in which the computer programs executed by the CPU 110 and data used at the time of control by the CPU 110 are temporarily stored. Further, data used by the LLCP processing section 130 is stored in the memory 111.

The application execution section 120 executes applications which use an LLCP. The application execution section 120 may execute a plurality of applications simultaneously. The applications executed by the application execution section 120 each have individual service access points (SAP).

The LLCP connection processing section 131 executes data transfer between corresponding applications (applications executed by the application execution section 120), in accordance with a specified transfer source service access point (SSAP) and destination service access point (DSAP).

The LLCP link protocol processing section 132 executes activation (that is, activation of the NFCIP-1 protocol), maintenance, and deactivation of an LLCP link.

The encryption processing section 133 executes encryption processes provided by encryption systems other than NFC-SEC, when near field non-contact wireless communication encrypted between the communication apparatus 100 and the communication apparatus 200 is executed. The encryption processing section 133 executes, as an encryption process, for example, the encryption of data columns to be communicated, the generation of a message authentication code (MAC), the generation of random numbers, or the like.

The NFC-SEC protocol processing section 134 processes a protocol provided by NFC-SEC. There is an SSE (Shared SEcret service) and an SCH (Secure CHannel service) in the protocol provided by NFC-SEC. The SSE is a service which generates shared secret information between devices using NFC-SEC, and is shared between the devices. Further, the SCH is a service which executes encryption communication between devices using NFC-SEC by using the shared secret information shared by the SSE, and communication of all channels is encrypted. The NFCIP-1 protocol processing section 135 processes the protocol provided by the NFCIP-1.

The LLCP processing section 130 shown in FIG. 2 may be implemented, for example, on one IC chip as a non-contact wireless chip (CLF; Contactless Front End).

Heretofore, a functional configuration example of the communication apparatus 100 according to an embodiment of the present disclosure has been described by using FIG. 2. As described above, the communication apparatus 200 has a functional configuration the same as that of the communication apparatus 100 shown in FIG. 2. Also, by having a configuration such as that shown in FIG. 2, it becomes possible for the communication apparatus 100 and the communication apparatus 200 according to an embodiment of the present disclosure to perform a selection of the connections or layers to be encrypted, when performing near field non-contact wireless communication having a simultaneous communication function with a plurality of connections.

Next, while an operation example of the communication apparatus 100 according to an embodiment of the present disclosure will be described, the structure and the like of the various commands used by the communication apparatus 100 and the communication apparatus 200 according to an embodiment of the present disclosure will be described prior to a detailed description for the operation examples of the communication apparatus 100.

### [Examples of the Protocol Data Unit]

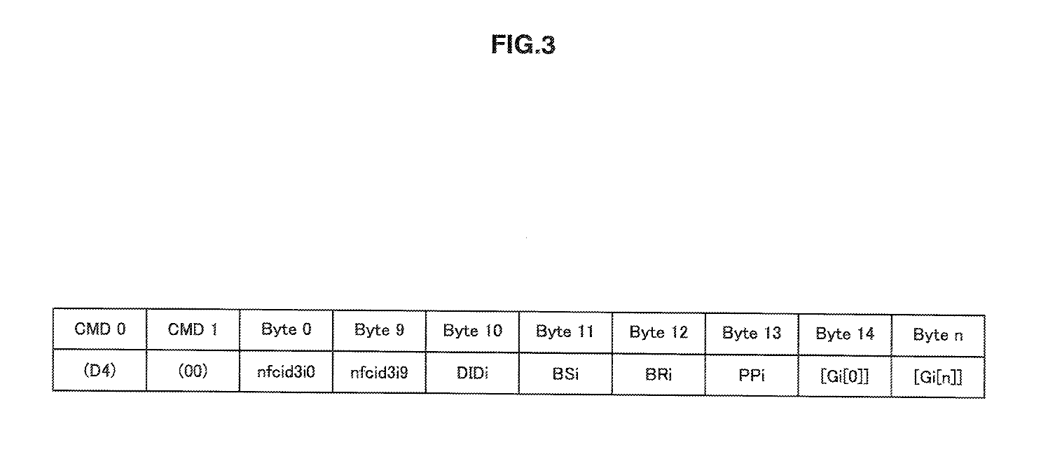

FIG. 3 is an explanatory diagram which shows a structure of a command ATR_REQ, which is a request command prepared by ISO/IEC 18092. The command ATR_REQ is transmitted to a target, at the time when an initiator notifies attribute information (specifications) of itself to the target and requests attribute information of the target. Here, there are transfer rates or the like of data, which can be transmitted or received by this initiator or target, as attribute information of the initiator or the target. Note that, other than attribute information of the initiator, an NFCID or the like which specifies this initiator is arranged in the command ATR_REQ, and the target recognizes the attribute information of the initiator and the NFCID by receiving the command ATR_REQ.

As shown in FIG. 3, the command ATR_REQ is constituted of, from the head (the left side within the figure), a CMD 0 field, a CMD 1 field, and Byte 0 to Byte n+14 fields (n is an integer value of 0 or above).

The values “D4” and “00”, which show that this command is a command ATR_REQ, are stored in the CMD 0 field and the CMD 1 field, respectively. NFCID (nfcid3i0 to nfcid3i9), which specify the communication apparatus (initiator) transmitting this command ATR_REQ, are stored in the Byte 0 to Byte 9 fields. DIDi, which is the device ID of the initiator transmitting this command ATR_REQ, is set in the Byte 10 field. The Byte 10 field is also called a DIDi field.

A bit rate (transfer rate) BSi at which the initiator transmitting this command ATR_REQ can transmit data is set in the Byte 11 field. A bit rate (transfer rate) BRi at which the initiator transmitting this command ATR_REQ can receive data is set in the Byte 12 field.

An option parameter PPi for the initiator transmitting this command ATR_REQ is set in the Byte 13 field. For example, a parameter which shows that the device itself is capable of performing processes by NFC-SEC is set in this Byte 13 field.

The Byte 14 to Byte 14+n fields are each fields in which various types of information specified by a designer or the like are set, and are fields which are prepared as options. The value n is capable of being changed by the designer or the like, and is an integer value of 0 or above. This value n is set in the PPi field, such as described later. Hereinafter, each of the n number of Gi fields will be called Gi to Gi[n] fields in this arrangement order (the order from the left side within the figure).

In the present embodiment, the communication apparatus 100 which is an initiator transmits to a target by including information, such as the encryption system to be used by the initiator and the channels to be encrypted, in the command ATR_REQ. While it will be described specifically later, the communication apparatus 100 transmits to the target by including information, such as the encryption system to be used and the channels to be encrypted, in the Byte 13 field onwards of the command ATR_REQ shown in FIG. 3.

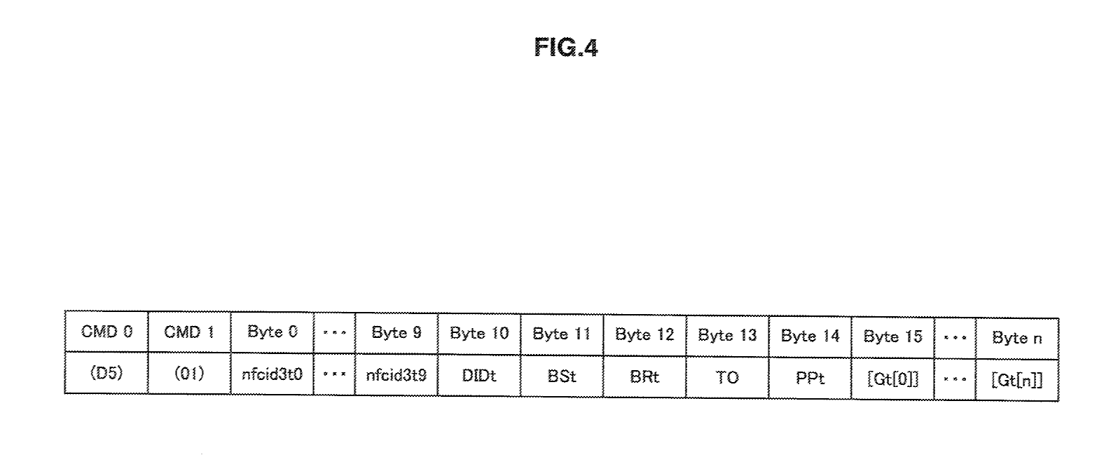

FIG. 4 is an explanatory diagram which shows a structure of a command ATR_RES, which is a response command prepared by ISO/IEC 18092. In the case where the target receives a command ATR_REQ, the command ATR_RES is transmitted to the initiator as a response to this command ATR_REQ. Attribute information of the target, an NFCID, or the like is arranged in the command ATR_RES.

As shown in FIG. 4, the command ATR_RES is constituted of, from the head (the left side within the figure), a CMD 0 field, a CMD 1 field, and Byte 0 to Byte n+15 fields (n is an integer value of 0 or above).

The values “D5” and “01”, which show that this command is a command ATR_RES, are stored in the CMD 0 field and the CMD 1 field, respectively. Data similar to that of the Byte 0 to Byte 12 fields of the command ATR_REQ described above are set in the Byte 0 to Byte 12 fields. That is, NFCID, which specify the device transmitting this command ATR_RES, that is, the target, are stored in the Byte 0 to Byte 9 fields. A device ID which specifies the initiator transmitting this command ATR_REQ, or zero, is set in the Byte 10 field. The Byte 10 field is also called a DIDt field.

A bit rate (transfer rate) BSt at which the target transmitting this command ATR_RES can transmit data is set in the Byte 11 field. A bit rate (transfer rate) BRt at which the target transmitting this command ATR_RES can receive data is set in the Byte 12 field. A value TO for a time-out of the target is set in the Byte 13 field.

The Byte 14 field is similar to that of the Byte 13 field of the command ATR_REQ. That is, an option parameter PPt for the target transmitting this command ATR_RES is set in the Byte 14 field. Note that hereinafter, the Byte 14 field of the command ATR_RES will also be called a PPt field.

The Byte 15 to Byte 15+n fields are each the same as those of the Byte 14 to Byte 14+n fields of the command ATR_REQ. That is, the Byte 15 to Byte 15+n fields are each fields in which various types of information specified by applications, settings or the like of an upper layer are set, and are fields prepared as options. The value n is capable of being changed by the designer or the like, and is an integer value of 0 or above. Hereinafter, each of the n number of Gt fields will be called Gt to Gt[n] fields in this arrangement order (in the order from the left side within FIG. 4).

In the present embodiment, the communication apparatus 200 which is a target transmits to an initiator by including information, such as the encryption system to be used with the initiator and the channels to be encrypted, in the command ATR_RES, in a form responding to the command ATR_REQ. While it will be described specifically later, the communication apparatus 200 transmits to the initiator by including information, such as the encryption system to be used and the channels to be encrypted, in the Byte 14 field onwards of the command ATR_RES shown in FIG. 4.

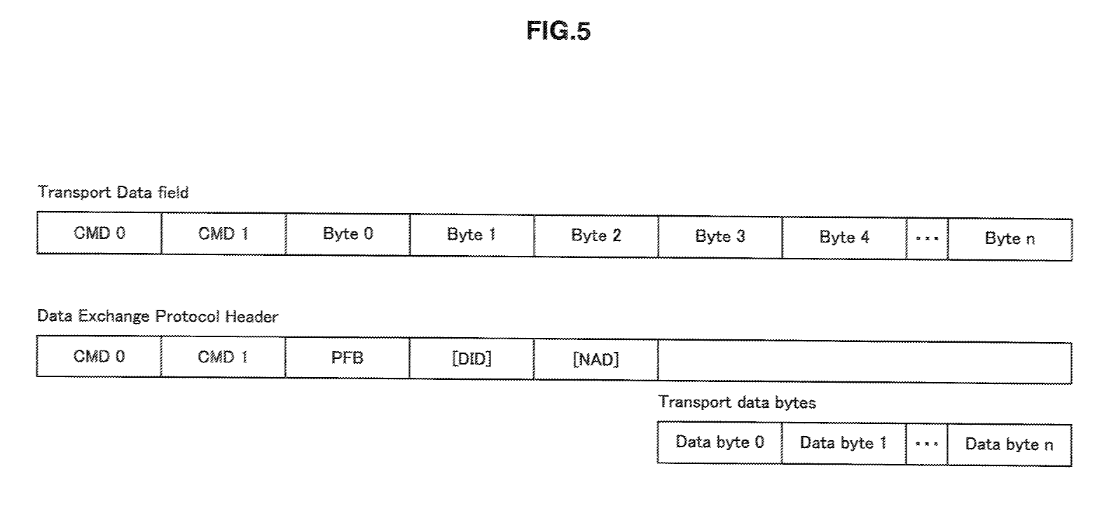

FIG. 5 is an explanatory diagram which shows a structure of a command DEP_REQ, which is a request command, and a command DEP_RES, which is a response command, prepared by ISO/IEC 18092. The command DEP_REQ is transmitted at the time when the initiator performs transmission/reception (data exchange with the target) of data (so-called actual data), and the data to be transmitted to the target is arranged in here. The command DEP_RES is transmitted by the target as a response to the command DEP_REQ, and the data to be transmitted to the initiator is arranged in here. Therefore, data is transmitted from the initiator to the target by the command DEP_REQ, and data is transmitted from the target to the initiator by the command DEP_RES which is a response to this command DEP_REQ.

In the present embodiment, the generation of shared secret information, the transmission/reception of encrypted data, the release of connections and the like are performed by the command DEP_REQ and the command DEP_RES. The specific sequence will be described in detail afterwards.

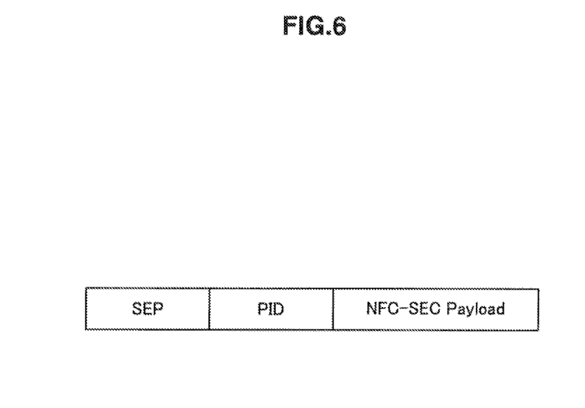

FIG. 6 is an explanatory diagram which shows a structure of a protocol data unit of NFC-SEC. As shown in FIG. 6, the protocol data unit of NFC-SEC is constituted of each field of an SEP (Secure Exchange Protocol), a PID (Protocol Identifier), and an NFC-SEC Payload.

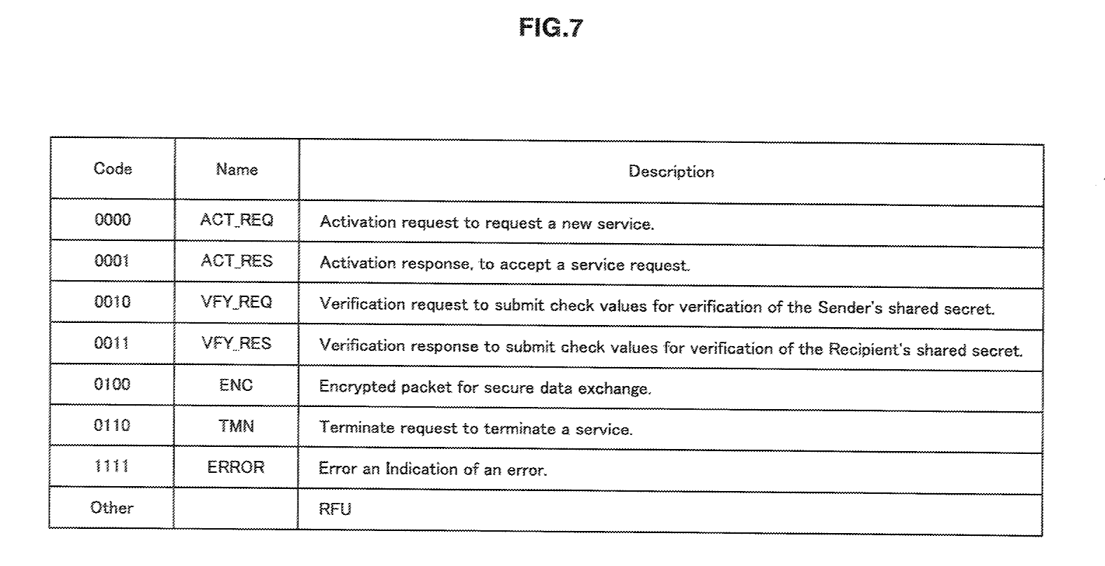

Data, such as the type of protocol data unit of NFC-SEC and which of SSE and SCH is used, is stored in the SEP field. FIG. 7 is an explanatory diagram which shows a correlation between the codes stored in the SEP field and the contents shown by these codes. A PID used by an encryption process by NFC-SEC is stored in the PID field. Data used by an encryption process by NFC-SEC is stored in the NFC-SEC Payload field.

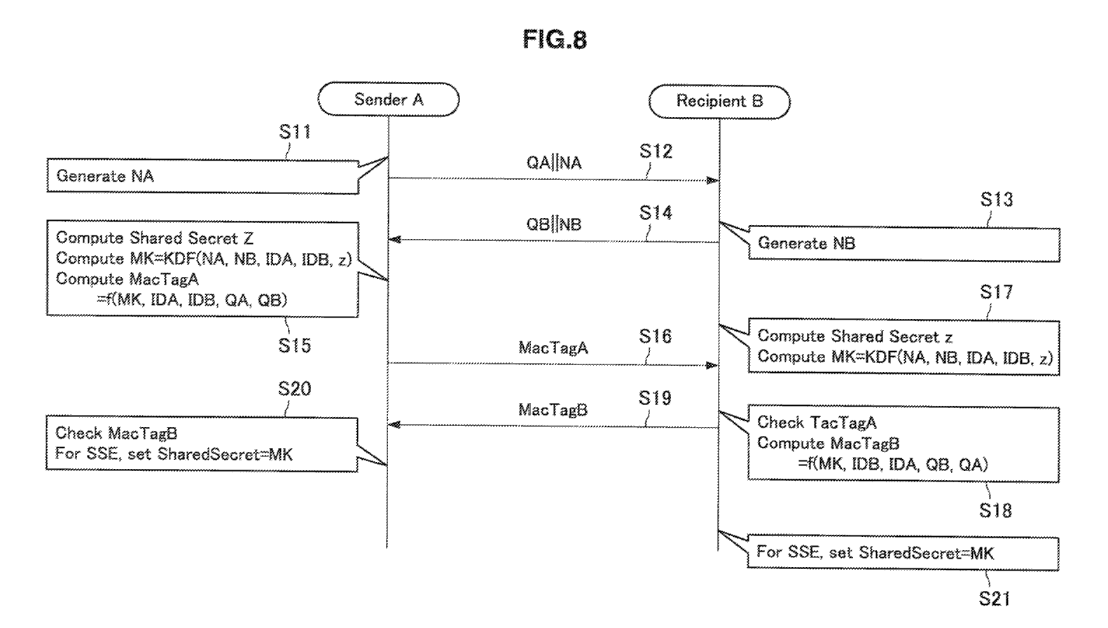

FIG. 8 is a flow chart which shows an encryption key generation process by NFC-SEC. In FIG. 8, the processes between a Sender A and a Recipient B are shown. The Sender A generates a temporary value NA (step S11), and transmits, to the Recipient B, a value QA secured inside the Sender A and the temporary value NA generated in step S11 (step S12). The Recipient B generates a temporary value NB (step S13), and transmits, to the Sender A, a value QB secured inside the Recipient B and the temporary value NB generated in step S13 (step S14).

Then, the Sender A generates a key confirmation tag MacTagA, from the information transmitted from the Recipient B (step S15), and transmits the MacTagA to the Recipient B (step S16). After verifying the MacTagA, the Recipient B generates a key conformation tag MacTagB (steps S17 and S18), and transmits the MacTagB to the Sender A (step S19).

The Sender A verifies the MacTagB, and sets the MacTagB as shared secret information (step S20). Similarly, the Recipient B sets the MacTagA as shared secret information (step S21).

Note that the details of the encryption key generation process by NFC-SEC are disclosed in “NFC-SEC-01: NFC-SEC Cryptography Standard using ECDH and AES”.

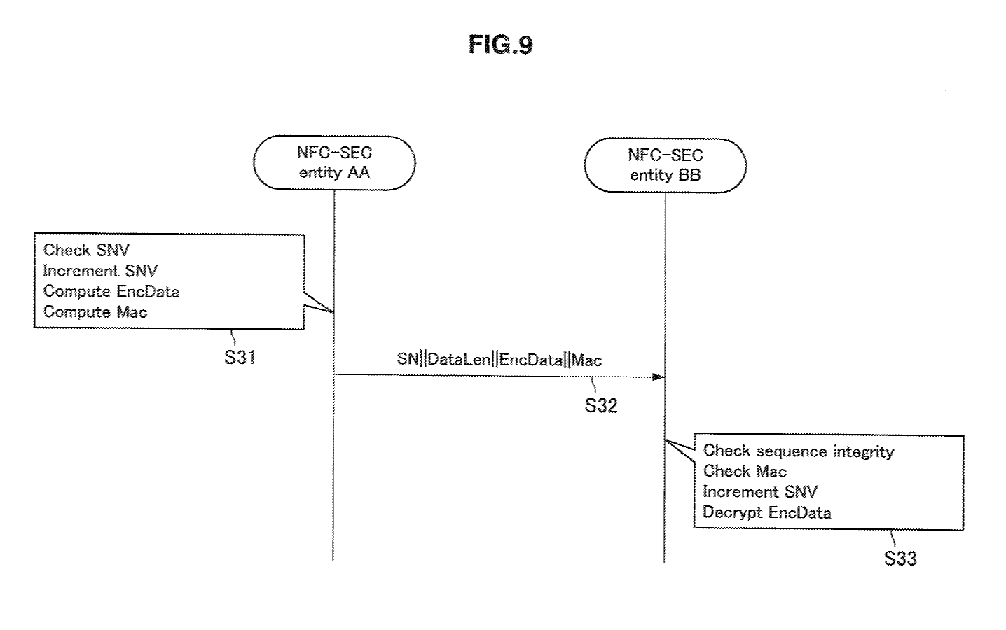

FIG. 9 is a flow chart which shows an encryption communication process by NFC-SEC. In FIG. 9, the processes between entities AA and BB, which execute an encryption communication process by NFC-SEC, are shown.

The entity AA encrypts data to be transmitted, by using the shared secret information (step S31), and transmits the encrypted data to the entity BB along with necessary information for data length or other decryption (step S32). The entity BB decrypts the data received from the entity AA, by using the shared secret information (step S33). By this series of events, an encryption communication process by NFC-SEC is performed between the entities AA and BB.

Note that the details of the encryption communication process by NFC-SEC are disclosed in “NFC-SEC-01: NFC-SEC Cryptography Standard using ECDH and AES”.

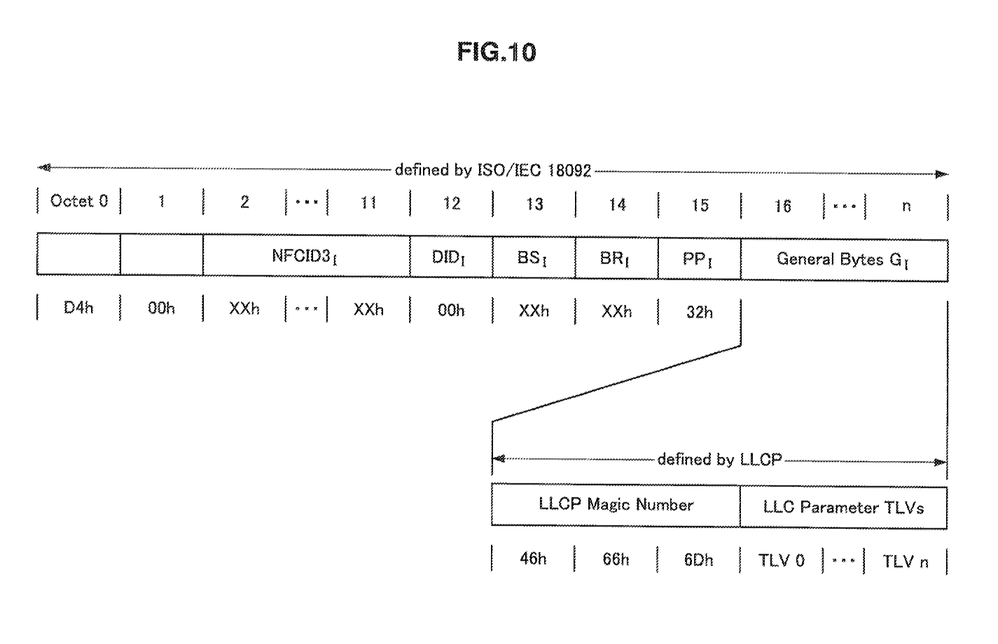

FIG. 10 is an explanatory diagram which shows a structure of a command ATR_REQ and the LLC parameters which are request commands prepared by ISO/IEC 18092.

The command ATR_REQ is transmitted to the target, at the time when the initiator notifies the attributes (specifications) of itself to the target and requests attributes of the target. Here, there are transfer rates or the like of data, which can be transmitted or received by this initiator or target, as attributes of the initiator or the target. Note that, other than attributes of the initiator, an NFCID or the like which specifies this initiator is arranged in the command ATR_REQ, and the target recognizes the attributes of the initiator and the NFCID by receiving the command ATR_REQ.

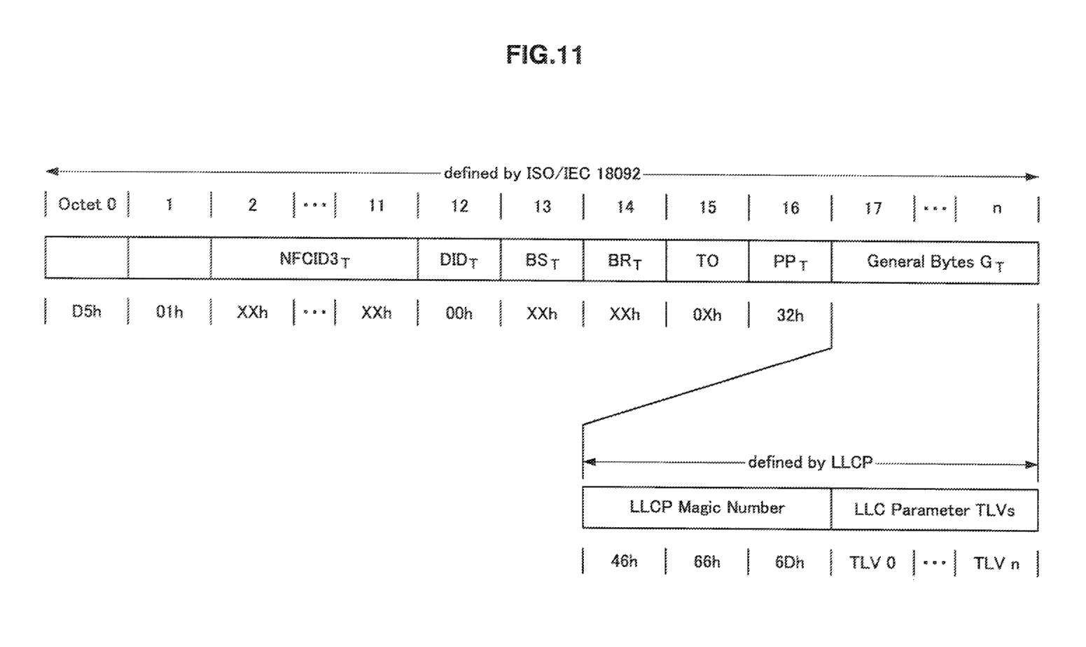

FIG. 11 is an explanatory diagram which shows a structure of a command ATR_RES and the LLC parameters which are response commands prepared by ISO/IEC 18092.

In the case where the target receives the command ATR_REQ, the command ATR_RES is transmitted to the initiator as a response to this command ATR_REQ. Attributes of the target and an NFCID or the like are arranged in the command ATR_RES.

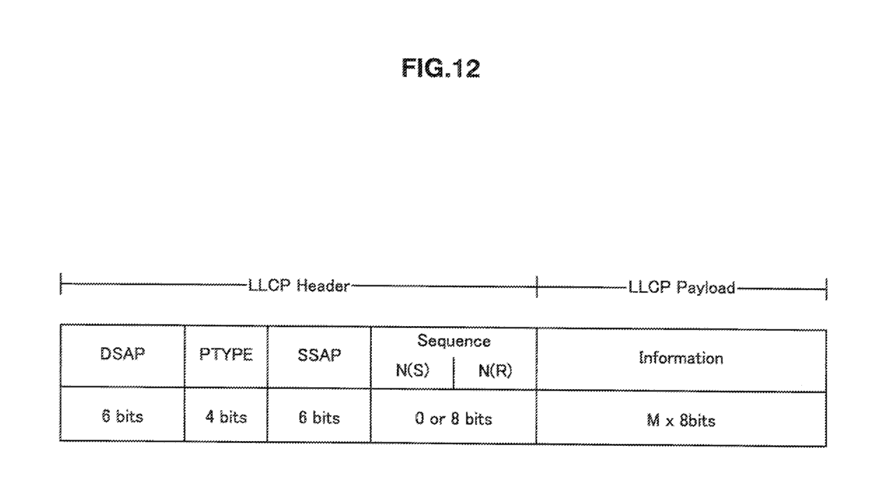

FIG. 12 is an explanatory diagram which shows a structure of an LLC PDU. As shown in FIG. 12, the LLC PDU is constituted of a DSAP field, a PTYPE (Payload data unit type) field, an SSAP field, a Sequence field, and an Information field. The DSAP field, the PTYPE field, the SSAP field, and the Sequence field are an LLCP Header, and the Information field is an LLCP Payload.

The address of the DSAP is stored in the DSAP field. The type of PDU is stored in the PTYPE field. The type of PDU is defined in the NFC Forum Logical Link Control Protocol, and a value corresponding to the type of this PDU is stored. The address of the SSAP is stored in the SSAP field. The sequence number of the LLC PDU is stored in the Sequence field. Information transferred by the LLC PDU is stored in the Information field.

Such commands and processes are prepared in the communication apparatus 100 and the communication apparatus 200 according to an embodiment of the present disclosure. However, such as described above, when encrypting an LLC SDU (Service Data Unit), which is data of the upper layer of an LLC PDU, by using NFC-SEC SCH which is a security option for NFCIP-1, the entire LLC PDU is encrypted. Therefore, when performing encryption by using NFC-SEC SCH, a process is not able to be implemented in which only some of the connections on the LLC perform communication where encryption is not necessary.

Accordingly, an embodiment of the present disclosure adds and defines parameters in an existing data structure, so that the connections or layers to be encrypted are capable of being selected. Specifically, an embodiment of the present disclosure adds, to an existing data structure, parameters so that the connections or layers to be encrypted can be selected. In this way, an embodiment of the present disclosure can implement flexible operations, such as encrypting all the connections or encrypting only a part of the connections.

Table 1 is a table which shows the parameters added and defined in an embodiment of the present disclosure. As shown in Table 1, the following three parameters are added and defined in an embodiment of the present disclosure. In Table 1, “May” of “included” has the meaning of parameters which are specified arbitrarily. Further, “In PDU Type” represents the type of PDU.

TABLE 1
(Added and defined parameters)

| | | | In PDU |
|---|---|---|---|
| Name | Description | Included | Type |
| NFC-SEC PID TLV | A list of PID | MAY | PAX |
| | provided by NFC-SEC | | |
| | is listed. | | |
| Secure LLC TLV | A generation method | MAY | PAX |
| | of the layers | | |
| | protecting the | | |
| | NFCIP-1 SDU and the | | |
| | shared secret | | |
| | information of only | | |
| | necessary cases, and | | |
| | the number of shared | | |
| | secret information | | |
| | to be generated, are | | |
| | specified. | | |
| Secure | In the case where | MAY | CONNECT |
| Connection TLV | the generation | | |
| | method of the shared | | |
| | secret information | | |
| | is specified, shared | | |
| | secret information | | |
| | number to be used in | | |
| | this connection is | | |
| | specified. | | |

Note that in the case were the NFCIP-1 is that of a lower layer, an LLCP is provided that uses ATR_REQ and ATR_RES instead of PAX PDU. Therefore, “NFC-SEC PID TLV” and “Secure LLC TLV” within the parameters shown in Table 1 are exchanged by the ATR_REQ and the ATR_RES. Note that in the case where data is not encrypted between the initiator and the target, “Secure LLC TLV” and “Secure Connection TLV” are not used.

Table 2 is a table which describes “NFC-SEC PID TLV” within the added and defined parameters shown in Table 1. “NFC-SEC PID TLV” is used for exchanging the encryption systems which can be used, between the initiator and the target.

TABLE 2
(Description of NFC-SEC PID TLV)

| Tag | Len | Value | Description |
|---|---|---|---|
| 0Ah | N | Byte | A list of PID showing the |
| | | array | encryption methods of NFC-SEC is |
| | | | listed. |

Table 3 is a table which describes “Secure LLC TLV” within the added and defined parameters shown in Table 1. “Secure LLC TLV” is used for providing the encryption systems to be used and the number of layers to be encrypted, between the initiator and the target.

TABLE 3
(Description of Secure LLC TLV)

| Tag | Len | Value | | Description |
|---|---|---|---|---|
| 0Bh | 1 | 00h | | No protection |
| | | | | NFCIP-1 SDU is not protected, |
| | | | | or is specific to the |
| | | | | application |
| | 1 | 01h | | NFC-SEC SCH |
| | | | | NFCIP-1 SDU is protected by |
| | | | | using NFC-SEC SCH |
| | 2 | 02h | NS | NFC-SEC SSE |
| | | | | LLC SDU is protected by using |
| | | | | shared secret information |
| | | | | generated by NFC-SEC SSE |
| | | | | NS shows the number of shared |
| | | | | secret information to be |
| | | | | generated |
| | 3 | 03h | NS | Mutual authentication |
| | | | | LLC SDU is protected by using |
| | | | | shared secret information |
| | | | | generated by mutual |
| | | | | authentication |
| | | | | A system of mutual |
| | | | | authentication can use a |
| | | | | mechanism 3 (mutual |
| | | | | authentication using random |
| | | | | numbers) of ISO/IEC 9798-2, for |
| | | | | example |
| | | | | NS shows the number of shared |
| | | | | secret information to be |
| | | | | generated |

While three patterns of encryption processes are included in Table 3, the patterns of the encryption processes may be 4 or more. Further, in Table 3, mutual authentication is included as an encryption process other than that of NFC-SEC SCH and NFC-SEC SSE. An encryption process by mutual authentication may be executed by applications executed by the application execution section 110, for example. Note that since the processes are performed on the application side, for example, as an advantage of using an encryption system other than NFC-SEC SSE, a change or addition of an encryption system by a host will become easy.

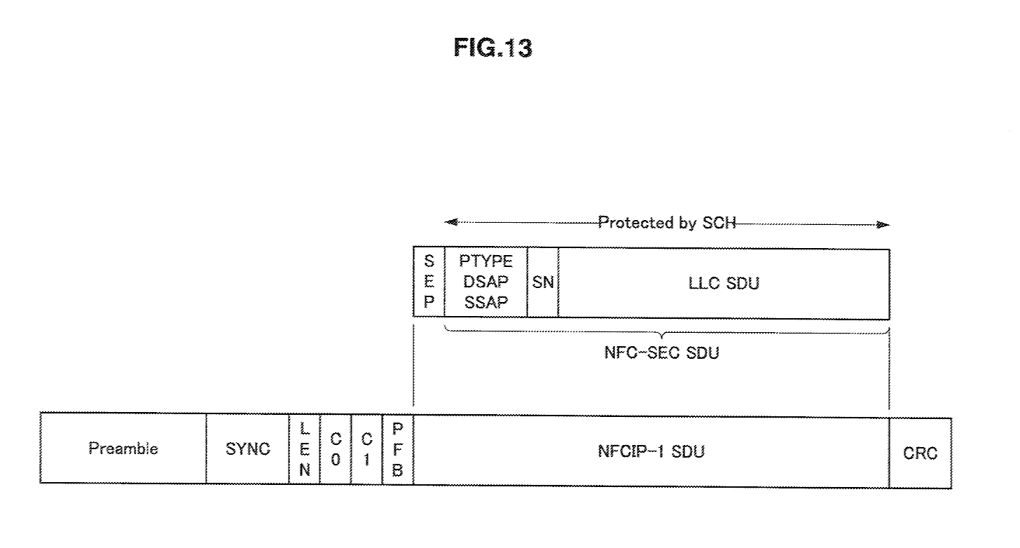

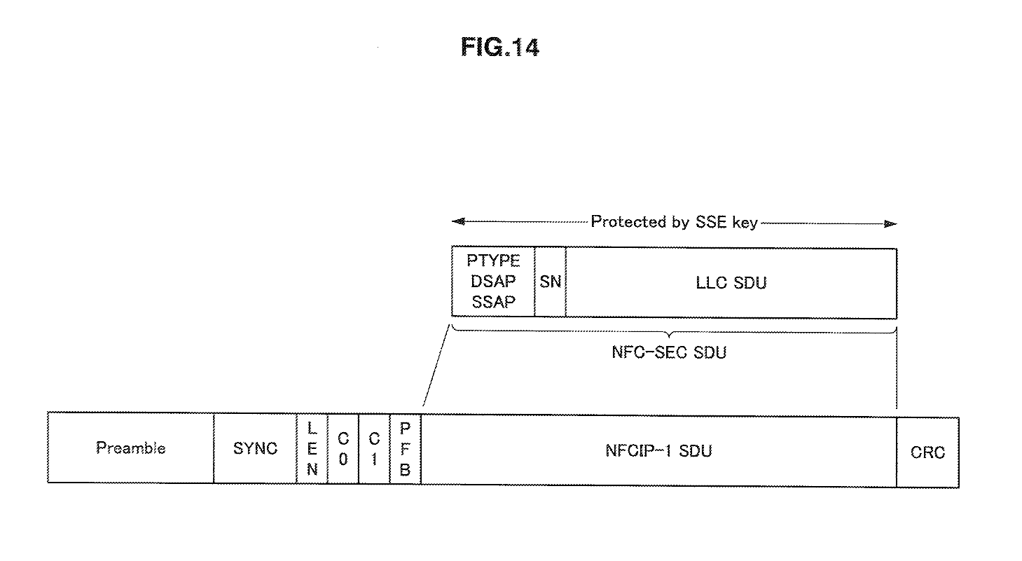

FIG. 13 and FIG. 14 are explanatory diagrams which show the range protected by NFC-SEC SCH and the range protected by NFC-SEC SSE or mutual authentication, respectively. As shown in FIG. 13, a PTYPE/DSAP/SSAP, an SN (Serial Number) and an LLC SDU are protected by NFC-SEC SCH. Further, such as shown in FIG. 14, an SN and an LLC SDU are protected by NFC-SEC SSE.

Table 4 is a table which describes “Secure Connection TLV” within the added and defined parameters shown in Table 1. “Secure Connection TLV” is used for exchanging which shared secret information is used, between the initiator and the target.

TABLE 4
(Description of Secure Connection TLV)

| Tag | Len | Value | | Specification |
|---|---|---|---|---|
| 0Ch | 2 | Type: | 0 . . . NS − 1 | In the case where the |
| | | 02h~ | | Value 1st byte of Secure |
| | | | | LLC TLV is 02h or 03h, |
| | | | | 02h or 03h is specified |
| | | | | in the 1st byte, and a |
| | | | | number is specified for |
| | | | | which shared secret |
| | | | | information is used in |
| | | | | the 2nd byte. From 0 up |
| | | | | to NS-1. |

By using such added and defined parameters, an embodiment of the present disclosure can implement flexible operations, such as encrypting all the connections or encrypting only a part of the connections. Hereinafter, operation examples of the communication apparatuses 100 and 200 according to an embodiment of the present disclosure will be described in detail.

In the case where LLC communication encrypted between the communication apparatus 100 which is an initiator and the communication apparatus 200 which is a target is executed, the encrypted LLC communication is executed in accordance with the following sequence.

First, activation of an NFCIP-1 protocol is performed between the communication apparatus 100 which is an initiator and the communication apparatus 200 which is a target. Activation of the NFCIP-1 protocol is performed by an exchange of the ATR_REQ and the ATR_RES.

When activation of the NFCIP-1 protocol is performed, to continue, the initiator and the target perform key generation and key sharing in the case where NFC-SEC is used or in the case where NFC-SEC is not used. In the case where NFC-SEC is used, the initiator and the target perform key generation and key sharing in accordance with the method provided by NFC-SEC such as described above. Further, in the case where NFC-SEC is not used, the initiator and the target perform key generation and key sharing, for example, by mutual authentication, challenge response authentication, or the like.

When key generation and key sharing is performed, to continue, the initiator and the target establish an LLC connection, and when an LLC connection is established, an encrypted LLC data exchange is performed. When the exchange of data is completed, the initiator and the target disconnect the LLC connection.

### [Operation Sequence Examples]

To continue, an example of an operation sequence of the communication apparatuses 100 and 200 according to an embodiment of the present disclosure will be described. First, an operation sequence of the case where data is not protected (data is not encrypted) between the communication apparatuses 100 and 200 according to an embodiment of the present disclosure will be described.

Table 5 is a table which shows an operation sequence of the case where data is not protected between the communication apparatuses 100 and 200 according to an embodiment of the present disclosure.

TABLE 5
(Sequence example of the case of no protection)

| Initiator→Target | Initiator←Target |
|---|---|
| ATR_REQ→ | |
| (PPi: b8 = 1, GBi: LLCP | |
| supported + | |
| PID = 01h) | |
| | ←ATR_RES |
| | (PPt: b8 = 1, GBt: LLCP |
| | supported + |
| | PID = 01h) |
| DEP_REQ Information PDU → | |
| LLC CONNECT | |
| | ←DEP_RES Information PDU |
| | LLC CC |
| DEP_REQ Information PDU→ | |
| LLC I | |
| (LLC SDU) | |
| | ←DEP_RES Information PDU |
| | LLC I |
| | (LLC SDU) |

In this operation sequence shown in FIG. 5, “Secure LLC TLV” shown by Table 1 is not exchanged between the initiator and the target, when the command ATR_REQ is initially transmitted from the initiator to the target. Therefore, in the case where data is not protected between the communication apparatuses 100 and 200, the communication apparatuses 100 and 200 operate in accordance with an operation sequence such as shown in Table 5.

Table 6 is a table which shows an operation sequence of the case where data is protected by using NFC-SEC SCH, between the communication apparatuses 100 and 200 according to an embodiment of the present disclosure. FIG. 7 can be referred to for ACT_REQ, ACT_RES, VFY_REQ, VFY_RES, and ENC shown in Table 6.

TABLE 6
(Sequence example of the case where NFC-SEC SCH is used)

| Initiator→Target | Initiator←Target |
|---|---|
| ATR_REQ→ | |
| (PPi: b8 = 1, GBi: LLCP | |
| supported + | |
| PID = 01h + Secure LLC | |
| TLV = 01h) | |
| A plurality of generation | |
| systems (Secure LLC TLV) | |
| may be included. In this | |
| case, the Target selects | |
| the generation system | |
| | ←ATR_RES |
| | (PPi: b8 = 1, GBt: LLCP |
| | supported + |
| | PID = 01h + Secure LLC |
| | TLV = 01h) |
| DEP_REQ Information PDU → | |
| SEC ACT_REQ ( ) | |
| | ←DEP_RES Information PDU |
| | SEC ACT_RES( ) |
| DEP_REQ Information PDU → | |
| SEC VFY_REQ ( ) | |
| | ←DEP_RES Information PDU |
| | SEC VFY_RES( ) |
| DEP_REQ Information PDU → | |
| SEC ENC | |
| LLC CONNECT | |
| *Since SCH is used, it is | |
| not necessary for Secure | |
| Connection TLV to be | |
| specified | |
| | ←DEP_RES Information PDU |
| | SEC ENC |
| | LLC CC |
| DEP_REQ Information PDU → | |
| SEC ENC | |
| LLC I | |
| (LLC SDU) | |
| | ←DEP_RES Information PDU |
| | SEC ENC |
| | LLC I |
| | (LLC SDU) |

In this operation sequence shown in Table 6, “Secure LLC TLV” shown by Table 1 is exchanged between the initiator and the target, when the command ATR_REQ is initially transmitted from the initiator to the target. Further, the value of “Secure LLC TLV” in the ATR_REQ and the ATR_RES is “01h”. That is, it can be declared that NFC-SEC SCH is used between the initiator and the target. Therefore, in the case where data is protected by using NFC-SEC SCH between the communication apparatuses 100 and 200, the communication apparatuses 100 and 200 operate in accordance with an operation sequence such as shown in Table 6.

Table 7 and Table 8 are tables which show an operation sequence of the case where data is protected by using NFC-SEC SSE, between the communication apparatuses 100 and 200 according to an embodiment of the present disclosure. Note that the operation sequence shown in Table 8 is executed continuing on from Table 7, and is divided into two tables for the sake of convenience. FIG. 7 can be referred to for ACT_REQ, ACT_RES, VFY_REQ, VFY_RES, and ENC shown in Table 7 and Table 8.

TABLE 7
(Sequence example of the case where NFC-SEC SSE is used)

| Initiator→Target | Initiator←Target |
|---|---|
| ATR_REQ→ | |
| (PPi: b8 = 1, GBi: LLCP | |
| supported + PID = 01h + Secure | |
| LLC TLV = 02h 03h) | |
| *In this example, the number | |
| of shared secret information | |
| generated is 3 | |
| | ←ATR_RES |
| | (PPi: b8 = 1, GBt: LLCP |
| | supported + PID = 01h + |
| | Secure LLC TLV = 02h 03h) |
| DEP_REQ Information PDU→ | |
| SEC ACT_REQ( ) | |
| | ←DEP_RES Information PDU |
| | SEC ACT_RES( ) |
| DEP_REQ Information PDU→ | |
| SEC VFY_REQ( ) | |
| Shared secret information 0 | ←DEP_RES Information PDU |
| is generated | VFY_RES( ) |
| | Shared secret information 0 |
| | is generated |
| DEP_REQ Information PDU→ | |
| SEC ACT_REQ( ) | |
| | ←DEP_RES Information PDU |
| | SEC ACT_RES( ) |
| DEP_REQ Information PDU→ | |
| SEC VFY_REQ( ) | |
| Shared secret information 1 | ←DEP_RES Information PDU |
| is generated | SEC VFY_RES( ) |
| | Shared secret information 1 |
| | is generated |
| DEP_REQ Information PDU→ | |
| SEC ACT_REQ( ) | |
| | ←DEP_RES Information PDU |
| | SEC ACT_RES( ) |
| DEP_REQ Information PDU→ | |
| SEC VFY_REQ( ) | |
| Shared secret information 2 | ←DEP_RES Information PDU |
| is generated | SEC VFY_RES( ) |
| | Shared secret information 2 |
| | is generated |
| DEP_REQ Information PDU→ | |
| LLC CONNECT | |
| (Secure Connection TLV = 0) | |
| Shared secret information | |
| number to be used is | |
| specified | |
| | ←DEP_RES Information PDU |
| | LLC CC |
| | Shared secret information |
| | of the specified number is |
| | used |

TABLE 8
(Sequence example of the case where NFC-SEC SSE is used)

| Initiator→Target | Initiator←Target |
|---|---|
| DEP_REQ Information PDU→ | |
| LLC I | |
| (Encrypted LLC SDU) | |
| | ←DEP_RES Information PDU |
| | LLC I |
| | (Encrypted LLC SDU) |
| DEP_REQ Information PDU→ | |
| LLC DISCONNECT | |
| SAP-SSN Table is updated | ←DEP_RES Information PDU |
| Shared secret information | LLC DM |
| remains. In this way, shared | |
| secret information can be | |
| reused by communication with | |
| the same partner. | |

In this operation sequence shown in Table 7 and Table 8, “Secure LLC TLV” shown by Table 1 is exchanged between the initiator and the target, when the command ATR_REQ is initially transmitted from the initiator to the target. Further, the value of “Secure LLC TLV” in the ATR_REQ and the ATR_RES is “02h 03h”. That is, it can be declared that NFC-SEC SSE is used between the initiator and the target, and the number of shared secret information is 3. Therefore, in the case where data is protected by using NFC-SEC SCH between the communication apparatuses 100 and 200, the communication apparatuses 100 and 200 operate in accordance with an operation sequence such as that shown in Table 7 and Table 8.

Table 9 is a table which shows an operation sequence of the case where data is protected by using mutual authentication between the communication apparatuses 100 and 200 according to an embodiment of the present disclosure. In the present embodiment, an operation sequence is shown of the case where encryption communication is performed by a challenge response authentication as the mutual authentication.

TABLE 9
(Sequence example of the case where
mutual authentication is used)

| Initiator→Target | Initiator←Target |
|---|---|
| ATR_REQ→ | |
| (PPi: b8 = 1, GBi: LLCP | |
| supported + | |
| PID = 01h 02h + Secure LLC | |
| TLV = 03h 01h) | |
| *In this example, the number | |
| of shared secret information | |
| generated is 1 | |
| | ←ATR_RES |
| | (PPi: b8 = 1, GBt: LLCP |
| | supported + |
| | PID = 01h 02h + Secure LLC |
| | TLV = 03h 01h) |
| DEP_REQ Information PDU→ | |
| Challenge = RB | |
| | ←DEP_RES Information PDU |
| | Response = Enc(RA, RB, B*) |
| | with K |
| DEP_REQ Information PDU→ | |
| Verification = Enc(RB, RA) | |
| with K | |
| Shared secret information 0 | ←DEP_RES Information PDU |
| is generated | Verification Response |
| | Shared secret information 0 |
| | is generated |
| DEP_REQ Information PDU→ | |
| LLC CONNECT | |
| (Secure Connection TLV = 0) | |
| Shared secret information | |
| number to be used is | |
| specified | |
| | ←DEP_RES Information PDU |
| | LLC CC |
| | Shared secret information |
| | of the specified number is |
| | used |
| DEP_REQ Information PDU→ | |
| LLC I | |
| (Encrypted LLC SDU) | |
| | ←DEP_RES Information PDU |
| | LLC I |
| | (Encrypted LLC SDU) |
| DEP_REQ Information PDU→ | |
| LLC DISCONNECT | |
| SAP-SSN Table is updated | ←DEP_RES Information PDU |
| Shared secret information | LLC DM |
| remains. In this way, shared | |
| secret information can be | |
| reused by communication with | |
| the same partner. | |

In this operation sequence shown in Table 9, “Secure LLC TLV” shown by Table 1 is exchanged between the initiator and the target, when the command ATR_REQ is initially transmitted from the initiator to the target. Further, the value of “Secure LLC TLV” in the ATR_REQ and the ATR_RES is “03h 01h”. That is, it can be declared that mutual authentication is used between the initiator and the target, and the number of shared secret information is 1. Therefore, in the case where data is protected by using mutual authentication between the communication apparatuses 100 and 200, the communication apparatuses 100 and 200 operate in accordance with an operation sequence such as that shown in Table 9.

Next, the operation sequences of the communication apparatuses 100 and 200 according to an embodiment of the present disclosure as described above will be described in more detail.

### [Operation Examples of the Communication Apparatus]

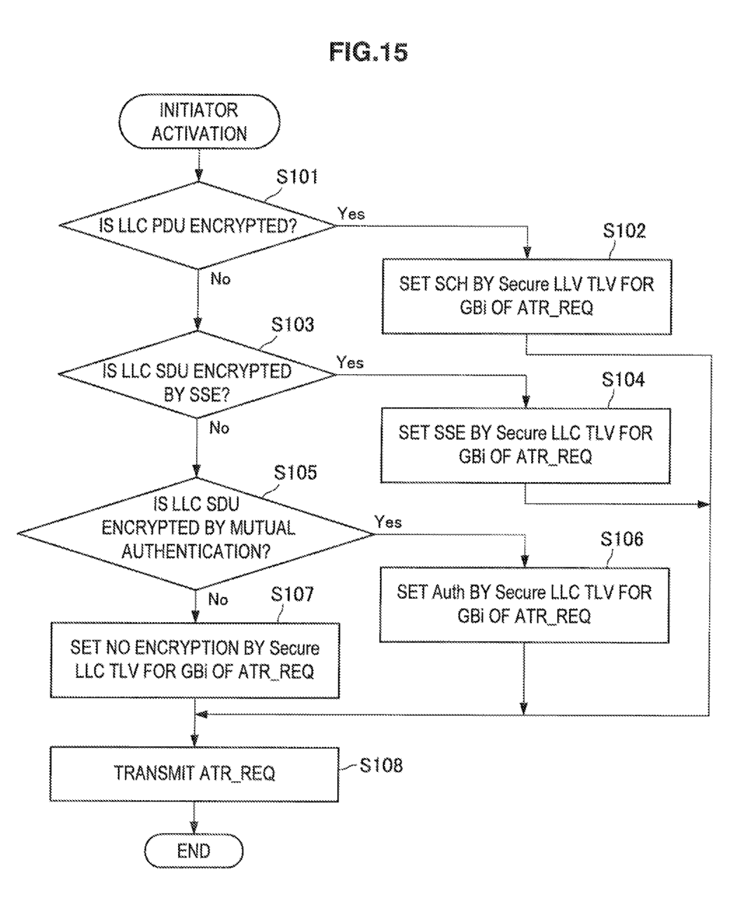

FIG. 15 is a flow chart which shows an operation example of the communication apparatus 100 according to an embodiment of the present disclosure. The flow chart shown in FIG. 15 is a flow chart which shows the activation of the NFCIP-1 and LLCP by the communication apparatus 100 which is an initiator. Note that the flow chart shown in FIG. 15 may be executed by the LLCP processing section 130, for example. Hereinafter, an operation example of the communication apparatus 100 according to an embodiment of the present disclosure will be described by using FIG. 15.

The communication apparatus 100 first judges whether or not communication is performed by encrypting the LLC PDU, when activated (step S101). As a result of the judgment of step S101, in the case where communication is performed by encrypting the LLC PDU, the communication apparatus 100 sets parameters for protecting the data by using NFC-SEC SCH, by a Secure LLC TLV for the GBi of the ATR_REQ (step S102).

On the other hand, as a result of the judgment of step S101, in the case where the LLC PDU is not encrypted, to continue, the communication apparatus 100 judges whether or not communication is performed by encrypting the LLC SDU by SSE (step S103). As a result of the judgment of step S103, in the case where communication is performed by encrypting the LLC SDU, the communication apparatus 100 sets parameters for protecting the data by using NFC-SEC SSE, by a Secure LLC TLV for the GBi of the ATR_REQ (step S104).

On the other hand, as a result of the judgment of step S103, in the case where the LLC SDU is not encrypted by SSE, to continue, the communication apparatus 100 judges whether or not communication is performed by encrypting the LLC SDU by mutual authentication (Auth) (step S105). As a result of the judgment of step S105, in the case where communication is performed by encrypting the LLC SDU by mutual authentication, the communication apparatus 100 sets parameters for protecting the data by using mutual authentication, by a Secure LLC TLV for the GBi of the ATR_REQ (step S106).

On the other hand, as a result of the judgment of step S105, in the case where the LLC SDU is not encrypted by mutual authentication (Ruth), the communication apparatus 100 sets parameters such as for communicating without encryption, by a Secure LLC TLV for the GBi of the ATR_REQ (step S107).

Finally, the communication apparatus 100 transmits the ATR_REQ, in which the parameters set in the above described steps S102, S104, S106 or S107 are included, to the communication apparatus 200 which is a target (step S108).

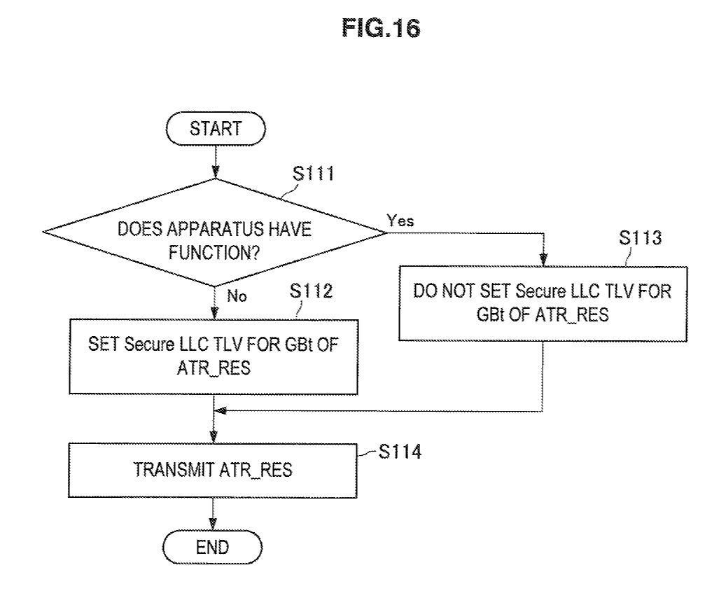

Heretofore, an operation example of the communication apparatus 100 according to an embodiment of the present disclosure has been described by using FIG. 15. The activation process of the NFCIP-1 and LLCP shown in FIG. 15 may be executed by the NFCIP-1 protocol processing section 135 or the LLCP link protocol processing section 132. Next, an operation example of the communication apparatus 200, which has received the ATR_REQ from the communication apparatus 100 which has generated this ATR_REQ, will be described by the flow chart shown in FIG. 16.

FIG. 16 is a flow chart which shows an operation example of the communication apparatus 200 according to an embodiment of the present disclosure. The flow chart shown in FIG. 16 shows an operation of the case where an ATR_RES is transmitted for the ATR_REQ transmitted from the communication apparatus 100 which is an initiator. Note that the flow chart shown in FIG. 16 may be executed, for example, by the LLCP processing section 130. Hereinafter, an operation example of the communication apparatus 200 according to an embodiment of the present disclosure will be described by using FIG. 16.

When the ATR_REQ is received from the communication apparatus 100, the communication apparatus 200 judges whether or not the apparatus itself has a function set by the Secure LLC TLV for the GBi of the ATR_REQ (step S111).

As a result of the judgment of the above described step S111, when it is judged that there is a function set by the Secure LLC TLV for the GBi of the ATR_REQ, the communication apparatus 200 sets the Secure LLC TLV for the GBt of the ATR_RES, so as to use this function (step S112). On the other hand, as a result of the judgment of the above described step S111, when it is judged that there is no function set by the Secure LLC TLV for the GBi of the ATR_REQ, the communication apparatus 200 does not set the Secure LLC TLV for the GBt of the ATR_RES (step S113).

Finally, the communication apparatus 200 transmits the ATR_RES, in which the set parameters are included, to the communication apparatus 100 which is an initiator (step S114).

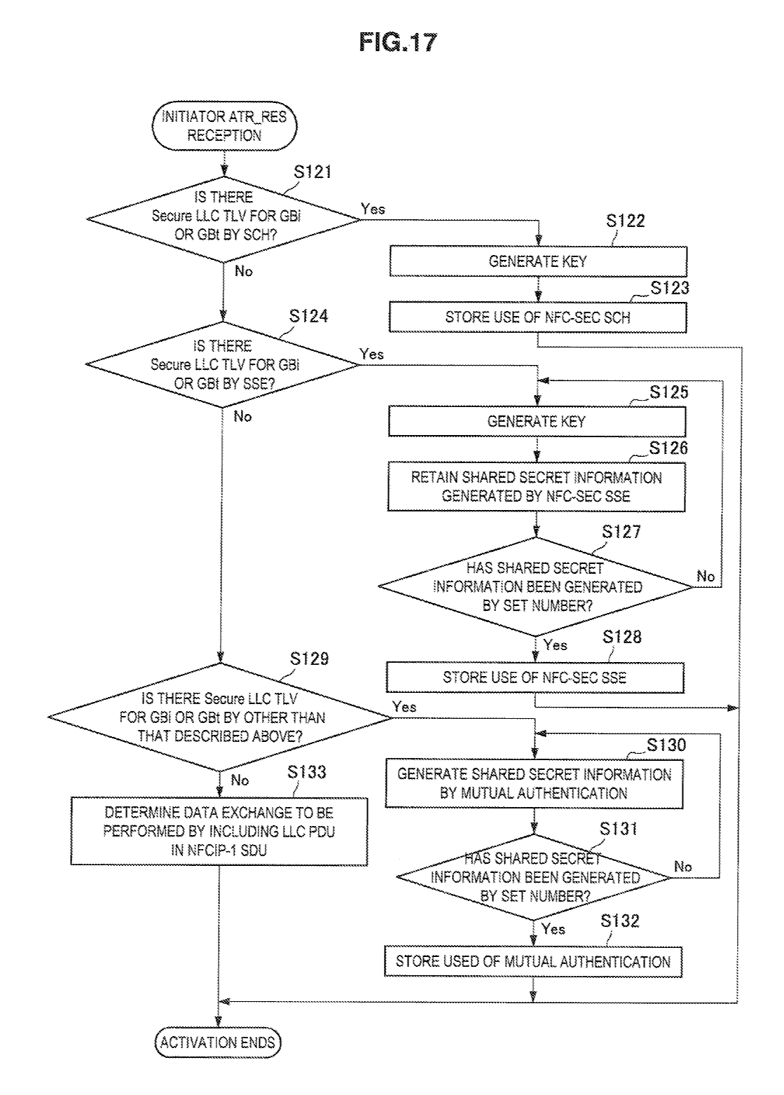

Heretofore, an operation example of the communication apparatus 200 according to an embodiment of the present disclosure has been described by using FIG. 16. An operation example of the communication apparatus 100, which has received the ATR_RES from the communication apparatus 200 which has generated this ATR_RES, will be described by the flow chart shown in FIG. 17.

FIG. 17 is a flow chart which shows an operation example of the communication apparatus 100 according to an embodiment of the present disclosure. The flow chart shown in FIG. 17 is a flow chart which shows the activation of the NFCIP-1 and LLCP by the communication apparatus 100 which is an initiator, and shows an operation example of the communication apparatus 100 which has received the ATR_RES from the communication apparatus 200. Heretofore, an operation example of the communication apparatus 100 according to an embodiment of the present disclosure will be disclosed by using FIG. 17.

First, the communication apparatus 100 judges whether or not the Secure LLC TLV for the GBi of the ATR_REQ and for the GBt of the ATR_RES is an SCH (step S121). As a result of the judgment of step S121, if the Secure LLC TLV for the GBi of the ATR_REQ and for the GBt of the ATR_RES is an SCH, the communication apparatus 100 executes a key generation process by NFC-SEC (step S122), and stores the use of the NFC-SEC SCH (step S123).

As a result of the judgment of step S121, if the Secure LLC TLV for either the GBi of the ATR_REQ or the GBt of the ATR_RES is not an SCH, to continue, the communication apparatus 100 judges whether or not the Secure LLC TLV for the GBi of the ATR_REQ and for the GBt of the ATR_RES is an SSE (step S124).

As a result of the judgment of step S124, if the Secure LLC TLV for the GBi of the ATR_REQ and for the GBt of the ATR_RES is an SSE, the communication apparatus 100 executes a key generation process by NFC-SEC (step S125), and retains the shared secret information generated by NFC-SEC SSE (step S126). To continue, the communication apparatus 100 judges whether or not the shared secret information is generated by only the number set by the ATR_REQ and the ATR_RES (step S127), and if the number of generated shared secret information has not reached the set number, the processes of steps S125 and S126 are repeated until reaching the set number. Then, when the shared secret information is generated by only the number set by the ATR_REQ and the ATR_RES, the communication apparatus 100 stores the use of the NFC-SEC SSE (step S128).

As a result of the judgment of step S124, if the Secure LLC TLV for either the GBi of the ATR_REQ or the GBt of the ATR_RES is not an SSE, to continue, the communication apparatus 100 judges whether or not the Secure LLC TLV for the GBi of the ATR_REQ and for the GBt of the ATR_RES is an encryption system other than SCH and SSE (mutual authentication by the present embodiment) (step S129).

As a result of the judgment of step S129, if the Secure LLC TLV for the GBi of the ATR_REQ and for the GBt of the ATR_RES is an encryption system other than SCH and SSE, the communication apparatus 100 generates shared secret information by this encryption system (step S130). To continue, the communication apparatus 100 judges whether or not the shared secret information is generated by only the number set by the ATR_REQ and the ATR_RES (step S131), and if the number of generated shared secret information has not reach the set number, the process of step S130 is repeated until reaching the set number. Then, when the shared secret information is generated by only the number set by the ATR_REQ and the ATR_RES, the communication apparatus 100 stores the use of this encryption system (step S132).

As a result of the judgment of step S129, if the Secure LLC TLV for either the GBi of the ATR_REQ or the GBt of the ATR_RES is not an encryption system other than SCH and SSE, the communication apparatus 100 determines that data exchange is performed without encryption, by including the LLC PDU in NFCIP-1 SDU (step S133).

Heretofore, an operation example of the communication apparatus 100 according to an embodiment of the present disclosure has been disclosed by using FIG. 17. Next, an operation example of the communication apparatuses 100 and 200 when an LLC connection is established will be described.

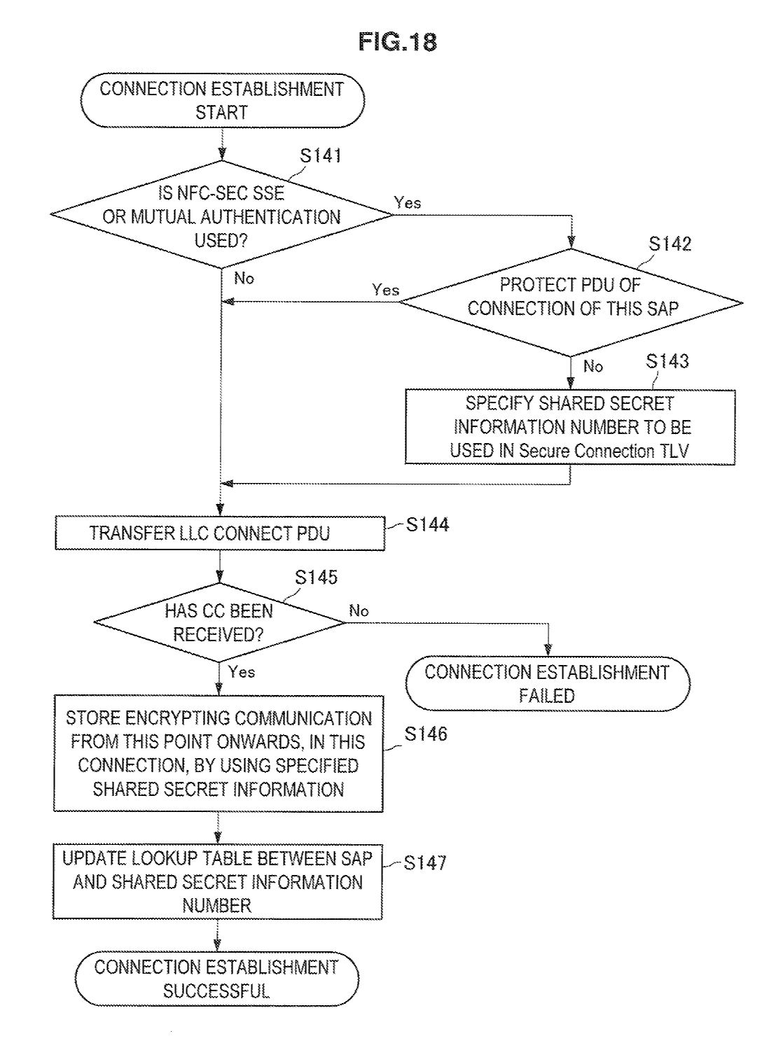

FIG. 18 is a flow chart which shows an operation example of the communication apparatus 100 according to an embodiment of the present disclosure. The flow chart shown in FIG. 18 shows an operation example of the communication apparatus 100 which requests the establishment of an LLC connection. Hereinafter, an operation example of the communication apparatus 100 according to an embodiment of the present disclosure will be described by using FIG. 18.

Upon requesting the establishment of an LLC connection, the communication apparatus 100 according to an embodiment of the present disclosure first judges whether or not NFC-SEC SSE or a mutual authentication system is used (step S141). The judgment for whether or not NFC-SEC SSE or a mutual authentication system is used may use information stored, for example, when performing the flow of the activation of the NFCIP-1 and LLCP shown in FIG. 17.

As a result of the judgment of step S141, in the case where NFC-SEC SSE or a mutual authentication system is used, to continue, the communication apparatus 100 judges whether or not the PDU of the connection of this SAP for establishing a connection is protected (step S142).

As a result of the judgment of step S142, in the case where the PDU of the connection of this SAP for establishing a connection is protected, to continue, the communication apparatus 100 specifies a shared secret information number to be used to the Secure Connection TLV (step S143).

As a result of the judgment of step S141, in the case where neither NFC-SEC SSE nor a mutual authentication system is used, as a result of the judgment of step S142, in the case where the PDU of a connection of this SAP for establishing a connection is not protected, or when a shared secret information number to be used is specified to the Secure Connection TLV in step S143, to continue, the communication apparatus 100 transmits the LLC CONNECT PDU to the communication apparatus 200 (step S144).

To continue, the communication apparatus 100 judges whether or not a CC (Connection Complete) for the LLC CONNECT PDU has been received from the communication apparatus 200 (step S145).

As a result of the judgment of the above described step S145, when it is judged that a CC for the LLC CONNECT PDU has been received from the communication apparatus 200, to continue, the communication apparatus 100 stores encrypting the communication from this point onwards in this connection, by using the specified shared secret information (step S146). Then, the communication apparatus 100 updates a lookup table between the SAP and the shared secret information number (step S147).

On the other hand, as a result of the judgment of the above described step S145, when it is judged that a CC for the LLC CONNECT PDU has not been received from the communication apparatus 200, the communication apparatus 100 fails to establish a connection with the communication apparatus 200.

Heretofore, an operation example of the communication apparatus 100 according to an embodiment of the present disclosure has been described by using FIG. 18. To continue, an operation example of the communication apparatus 200 which has received an establishment request of an LLC connection will be described.

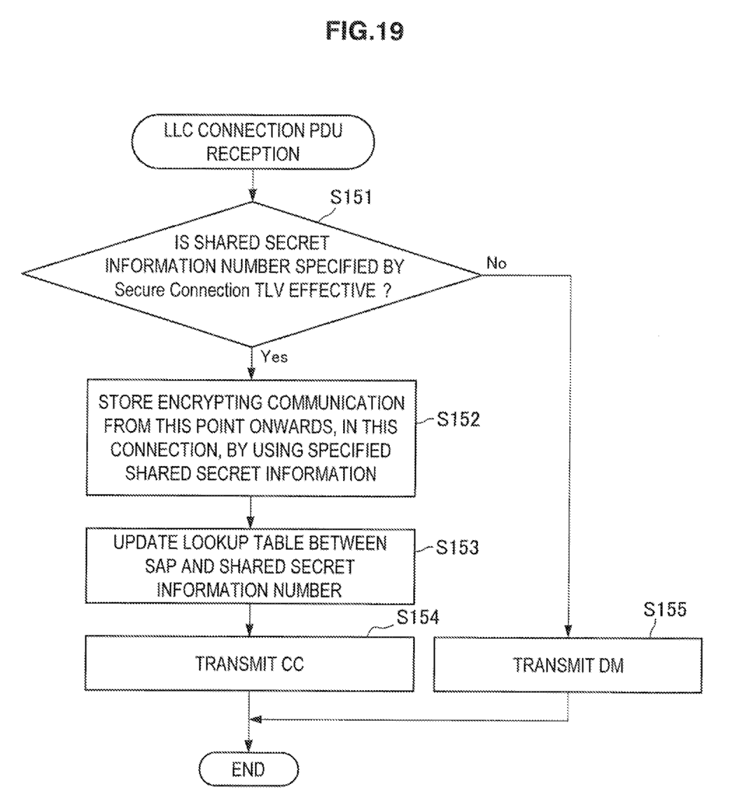

FIG. 19 is a flow chart which shows an operation example of the communication apparatus 200 according to an embodiment of the present disclosure. The flow chart shown in FIG. 19 shows an operation example of the communication apparatus 200 when an LLC CONNECT PDU is received from the communication apparatus 100. Hereinafter, an operation example of the communication apparatus 200 according to an embodiment of the present disclosure will be disclosed by using FIG. 19.

When the LLC CONNECT PDU is received from the communication apparatus 100, the communication apparatus 200 judges whether or not shared secret information number specified by the Secure Connection TLV is effective (step S151).

As a result of the judgment of the above described step S151, in the case where shared secret information number specified by the Secure Connection TLV is effective, the communication apparatus 200 stores encrypting the communication from this point onwards in this connection, by using the specified shared secret information (step S152). Then, the communication apparatus 200 updates the lookup table between the SAP and the shared secret information number (step S153), and transmits a CC (Connection Complete) for the LLC CONNECT PDU to the communication apparatus 100 (step S154).

On the other hand, as a result of the judgment of this above described step S151, in the case where shared secret information number set by the Secure Connection TLV is not effective, the communication apparatus 200 transmits a DM (Disconnected Mode) to the communication apparatus 100 (step S155).

Heretofore, an operation example of the communication apparatus 200 according to an embodiment of the present disclosure has been described by using FIG. 19. To continue, an operation example of the communication apparatuses 100 and 200 when performing LLC data exchange will be described.

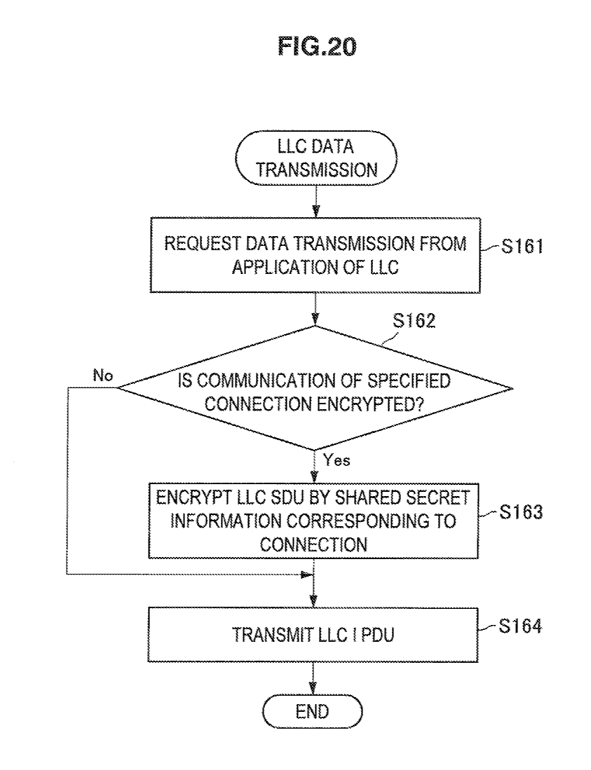

FIG. 20 is a flow chart which shows an operation example of the communication apparatus 100 according to an embodiment of the present disclosure. The flow chart shown in FIG. 20 shows an operation example of the communication apparatus 100 when performing LLC data exchange with the communication apparatus 200 which has established a connection. Hereinafter, an operation example of the communication apparatus 100 according to an embodiment of the present disclosure will be described by using FIG. 20.

When LLC data exchange is performed with the communication apparatus 200 which has established a connection, the communication apparatus 100 first requests data transmission from an application which performs data exchange by LLC (step S161). To continue, the communication apparatus 100 judges whether or not communication of a specific connection is encrypted (step S162).

As a result of the judgment of the above described step S162, in the case where the communication of the specific connection is encrypted, the communication apparatus 100 encrypts the LLC SDU by shared secret information corresponding to this connection (step S163). The encryption process executes an application, which is executed by the encryption processing section 133 and either the NFC-SEC protocol processing section 134 in the case according to a protocol of NFC-SEC, or the application execution section 120 in the case according to a protocol of NFC-SEC.

Finally, the communication apparatus 100 transmits LLC I (Information) PDU to the communication apparatus 200 which has established a connection (step S164). Information encrypted in the case where communication of the specific connection is encrypted, and plain text in the case of not being encrypted, is transmitted from the communication apparatus 100 to the communication apparatus 200.

Heretofore, an operation example of the communication apparatus 100 according to an embodiment of the present disclosure has been described by using FIG. 20. Next, an operation example of the communication apparatus 200 according to an embodiment of the present disclosure will be described.

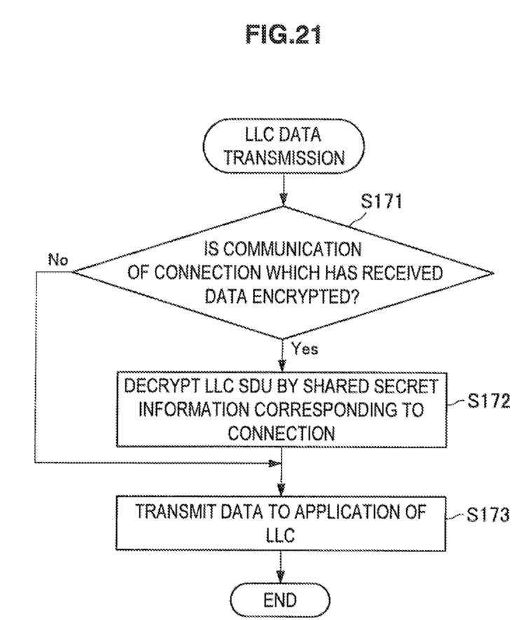

FIG. 21 is a flow chart which shows an operation example of the communication apparatus 200 according to an embodiment of the present disclosure. The flow chart shown in FIG. 21 shows an operation example of the communication apparatus 200, when performing LLC data exchange with the communication apparatus 100 which has established a connection. Hereinafter, an operation example of the communication apparatus 200 according to an embodiment of the present disclosure will be described by using FIG. 21.

When LLC data exchanged with the communication apparatus 100 which has established a connection is received, the communication apparatus 200 judges whether or not communication of this connection which has received the data is encrypted (step S171).

As a result of the judgment of the above described step S171, if communication of this connection which has received the data is encrypted, the communication apparatus 200 decrypts the LLC SDU by using shared secret information corresponding to this connection (step S172).

Finally, the communication apparatus 200 transmits the received data, or the received and decrypted data, to an application which performs data exchange by an LLC (step S173).

Heretofore, an operation example of the communication apparatus 200 according to an embodiment of the present disclosure has been described by using FIG. 21. Note that in the case where encryption is performed by SSE such as shown in FIG. 21, and in the case where encryption is applied by SCH, the processes by an LLC are not performed.

To continue, an operation example of the communication apparatuses 100 and 200 when the established LLC connection is disconnected will be described.

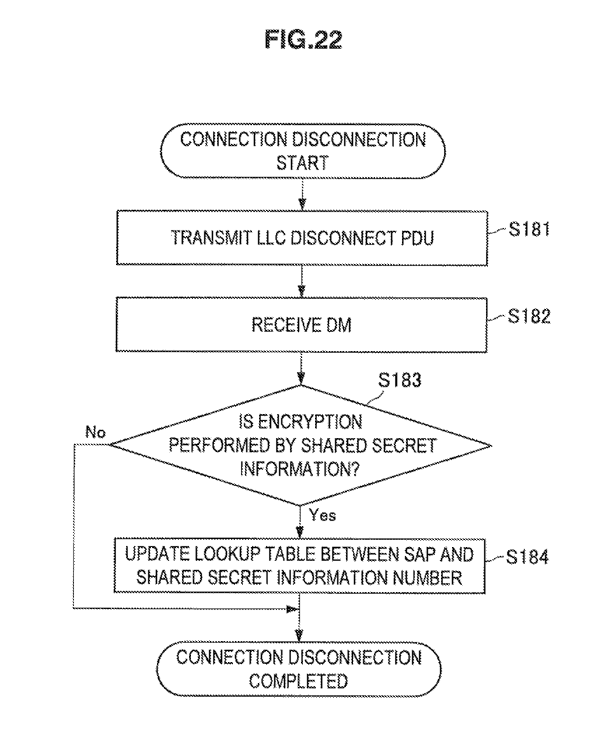

FIG. 22 is a flow chart which shows an operation example of the communication apparatus 100 according to an embodiment of the present disclosure. The flow chart shown in FIG. 22 is an operation example of the communication apparatus 100 when the LLC connection established with the communication apparatus 200 is disconnected. Hereinafter, an operation example of the communication apparatus 100 according to an embodiment of the present disclosure will be described by using FIG. 22.

As shown in FIG. 22, when the LLC connection established with the communication apparatus 200 is disconnected, the communication apparatus 100 first transmits an LLC DISCONNECT PDU towards the communication apparatus 200 (step S181).

To continue, when a DM transmitted from the communication apparatus 200 for the LLC DISCONNECT PDU is received (step S182), the communication apparatus 100 judges whether or not this connection to be disconnected is encrypted by shared secret information (step S183). As a result of the judgment of step S183, in the case where this connection to be disconnected is encrypted by shared secret information, the communication apparatus 100 updates the lookup table between the SAP and the shared secret information number (step S184).

By this series of events, the communication apparatus 100 can disconnect the LLC connection established with the communication apparatus 200. Further, shared secret information used between the communication apparatus 100 and the communication apparatus 200 is unused, by updating the lookup table between the SAP and the shared secret information number.

Heretofore, an operation example of the communication apparatus 100 according to an embodiment of the present disclosure has been described by using FIG. 22. Next, an operation example of the communication apparatus 200 according to an embodiment of the present disclosure will be described.

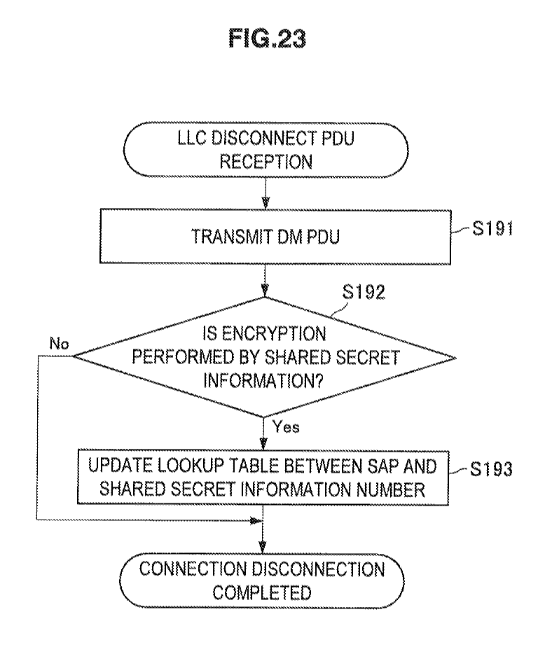

FIG. 23 is a flow chart which shows an operation example of the communication apparatus 200 according to an embodiment of the present disclosure. The flow chart shown in FIG. 23 is an operation example of the communication apparatus 200 when an LLC connection established with the communication apparatus 100 is disconnected. Hereinafter, an operation example of the communication apparatus 200 according to an embodiment of the present disclosure will be described by using FIG. 23.

When the LLC DISCONNECT PDU transmitted by the communication apparatus 100 in step S181 of FIG. 22 is received, the communication apparatus 200 transmits a DM PDU towards the communication apparatus 100 (step S191).

To continue, the communication apparatus 200 judges whether or not this connection to be disconnected is encrypted by shared secret information (step S192). As a result of the judgment of step S192, in the case where this connection to be disconnected is encrypted by shared secret information, the communication apparatus 200 updates the lookup table between the SAP and the shared secret information number (step S193).

By this series of events, the communication apparatus 200 can disconnect the LLC connection established with the communication apparatus 100. Further, shared secret information used between the communication apparatus 100 and the communication apparatus 200 is unused, by updating the lookup table between the SAP and the shared secret information number. In this case, the communication apparatus 100 and the communication apparatus 200 may completely erase the shared secret information used when performing encryption communication, from the viewpoint of security.

Heretofore, an operation example of the communication apparatus 200 according to an embodiment of the present disclosure has been disclosed by using FIG. 23. Next, an example of data managed by the communication apparatus 100 according to an embodiment of the present disclosure will be described.

### [Example of Data Managed by the Communication Apparatus]

As described above, the communication apparatus 100 manages a lookup table (SS N-V table) between the shared secret information number (SSN) and the value of the shared secret information (SSV), and a lookup table (SSP-SSN table) between the SAP and the shared secret information number.

Table 9 is a table which shows an initial state of the SS N-V table. As shown in Table 9, the initial state of the SS N-V table has a number of entries of 0.

TABLE 9
(Initial state of the SS N-V table)

| | |
|---|---|
| SSN | SSV |

Table 10 is a table which shows an initial state of the SSP-SSN table. As shown in Table 10, the SSP-SSN table has a number of entries at the initial state of 0.

TABLE 10
(Initial state of the SSP-SSN table)

| | | |
|---|---|---|
| DSAP | SSAP | SSN |

When shared secret information is generated, the communication apparatus 100 updates the SS N-V table. For example, when the number of shared secret information generated is 3, the communication apparatus 100 updates the SS N-V table such as shown in Table 11. Needless to say, the SSN and SSV shown in the following table are one example, and the SSN and SSV are not limited to such an example.

TABLE 11
(State of the SS N-V table)

| SSN | SSV |
|---|---|
| 0 | Xxxxxxx |
| 1 | Yyyyyyy |
| 2 | Zzzzzzzzz |

When a connection is established with the communication apparatus 200 after such shared secret information is generated, the communication apparatus 100 updates the SSP-SSN table. For example, in the case where DSAP which is a service access point of a transmission destination is DSAP=10, SSAP which is a service access point of a transmission source is SSAP=20, and Connection TLV=0, the communication apparatus 100 updates the SSP-SSN table such as shown in Table 12.

TABLE 12
(State of the SSP-SSN table)

| DSAP | SSAP | SSN |
|---|---|---|
| 10 | 20 | 0 |

When an additional connection is established with the communication apparatus 200 from the state of this Table 12, the communication apparatus 100 updates the SSP-SSN table. For example, in the case where DSAP=11, SSAP=21, and Connection TLV=1 in the new connection, the communication apparatus 100 updates the SSP-SSN table such as shown in Table 13.

TABLE 13
(State of the SSP-SSN table)

| DSAP | SSAP | SSN |
|---|---|---|
| 10 | 20 | 0 |
| 11 | 21 | 1 |

When the connection with the communication apparatus 200 is disconnected, from the state of this Table 13, the communication apparatus 100 updates the SSP-SSN table. For example, when the connection of DSAP=10, SSAP=20 and Connection TLV=0 is disconnected, the communication apparatus 100 updates the SSP-SSN table such as shown in Table 14.

TABLE 14
(State of the SSP-SSN table)

| DSAP | SSAP | SSN |
|---|---|---|
| 11 | 21 | 1 |

When a new connection is established with the communication apparatus 200, from the state of this Table 14, the communication apparatus 100 updates the SSP-SSN table. For example, in the case where DSAP=10, SSAP=20 and Connection TLV=0, the communication apparatus 100 updates the SSP-SSN table such as shown in Table 15.

TABLE 15
(State of the SSP-SSN table)

| DSAP | SSAP | SSN |
|---|---|---|
| 11 | 21 | 1 |
| 10 | 20 | 0 |

The communication apparatus 100 can understand which shared secret information of which connection is used, by managing such information, and can encrypt data by using shared secret information appropriate for the connection.

### 2. CONCLUSION

According to an embodiment of the present disclosure such as described above, a layer encrypted in link activation and a generation method of shared secret information are specified, when communicating by NFC LLCP. Also, according to an embodiment of the present disclosure, the shared secret information to be used is specified and communication data is encrypted, in a connection establishment, based on such a specified encryption layer and generation method of the shared secret information.

An embodiment of the present disclosure accomplish an effect which is capable of selecting whether an upper layer using an NFC LLCP (an application executed by the application execution section 120) performs encryption communication by NFC-SEC for all communications, or whether encryption communication is performed for each connection of the NFC LLCP. Therefore, the communication apparatuses 100 and 200 according to the present disclosure are capable of operating so that, for example, transfer of data is executed without encryption for data in which encryption communication is not necessary, and transfer of data by encryption is executed for data in which encryption communication is necessary, and it becomes possible to sufficiently use simultaneous communication functions with all the connections of the LLCP.

It is not necessary for each step in the processes executed by each apparatus according to embodiments of the present disclosure to be performed in a time series processes, in accordance with the order described in the sequences or flow charts. For example, each step in the processes executed by each apparatus may be performed in parallel, even if the processes are performed in an order difference from the order described as the flow charts.

Further, a computer program for causing hardware, such as a CPU, ROM and RAM built-into each apparatus, to exhibit functions similar to the configurations of each of the above described apparatuses can be created. Further, a storage medium storing this computer program can also be provided. Further, a series of processes can be executed with the hardware, by configuring each of the functional blocks shown by the functional block figures with the hardware.

It should be understood by those skilled in the art that various modifications, combinations, sub-combinations and alterations may occur depending on design requirements and other factors insofar as they are within the scope of the appended claims or the equivalents thereof.

For example, in the above described embodiments, while a determination of the encryption system is performed in the LLCP processing section 130, the present disclosure is not limited to such an example. For example, the determination of the encryption system may be performed by an application which is executed outside of the LLCP processing section 130, for example, by the application execution section 120, the LLCP processing section 130 may acquire an encryption system determined outside of the LLCP processing section 130 by the LLCP connection processing section 131, and encrypted communication may be executed based on the acquired encryption system.

For example, the priorities of the encryption system to be used may be changed, in accordance with the apparatus in which the above described processes are executed, or the applications executed within the apparatus. For example, the priorities may be set so that encryption communication is executed with priorities, when performing communication of applications which execute the transmission/reception of information in which inconveniences occur when the information is intercepted, such as connection information of wireless communication.

Further, for example, the shared secret information generated one-time may be reused. For example, at the time of retaining information of what shared secret information is used by which set of the SSAP and the DSAP, in the case where encryption communication is executed again by the same SSAP and DSAP, the shared secret information used previously may be reused. By reusing shared secret information which has been used, the generation process of shared secret information can be omitted, and encryption communication can be performed more quickly.

Additionally, the present technology may also be configured as below.

(1) An integrated circuit, including:

a communication processing section which communicates with another apparatus by non-contact communication capable of executing simultaneous communication by establishing a plurality of connections; and

an encryption processing section which executes an encryption process of data transmitted by the non-contact communication based on encryption information including connections to be encrypted when performing the non-contact communication with the another apparatus.

(2) The integrated circuit according to (1), further including:

an encryption system determination section which determines the connections to be encrypted and an encryption system when performing the non-contact communication with the another apparatus.

(3) The integrated circuit according to (2),

wherein the encryption system determination section exchanges, with the another apparatus, information of encryption systems which is usable with the another apparatus, prior to a determination of the encryption system to be used when performing the non-contact communication with the another apparatus.

(4) The integrated circuit according to (2) or (3),

wherein the encryption system determination section determines whether to encrypt all the connections or to encrypt a part of the connections.

(5) The integrated circuit according to any one of (2) to (4),

wherein the encryption system determination section is managed in association with information which identifies a value of an encryption key used for encrypted communication with the another apparatus, and the encryption key.

(6) The integrated circuit according to any one of (2) to (5),

wherein each application has an individual service access point, and

wherein the encryption system determination section is managed in association with information which identifies an encryption key used for encrypted communication between the service access point and the another apparatus.

(7) The integrated circuit according to (6),

wherein when the non-contact communication with the another apparatus ends, the encryption system determination section deletes the association of information which identifies the service access point and the encryption key.

(8) The integrated circuit according to (6) or (7),

wherein after encrypted communication between the service access point and the another apparatus ends, the encryption system determination section reuses a same encryption key in a case where the service access point executes encrypted communication again with a same apparatus.

(9) The integrated circuit according to any one of (1) to (8), further including:

an interface for acquiring the encryption information.

(10) A communication apparatus, including:

a communication processing section which communicates with another apparatus by non-contact communication capable of executing simultaneous communication by establishing a plurality of connections;

an encryption system determination section which determines the connections to be encrypted when performing the non-contact communication with the another apparatus; and

an encryption processing section which executes an encryption process of data transmitted by the non-contact communication based on a determination of the encryption system determination section.

(11) A communication method including a communication processing process which communicates with another apparatus by non-contact communication capable of executing simultaneous communication by establishing a plurality of connections,

wherein the communication processing process includes

determining the connections to be encrypted when performing the non-contact communication with the another apparatus, and

executing an encryption process of data transmitted by the non-contact communication based on a determination of the encryption system determination process.

(12) A computer program for causing a computer to execute a communication processing process which communicates with another apparatus by non-contact communication capable of executing simultaneous communication by establishing a plurality of connections,

wherein the communication processing process includes

determining the connections to be encrypted when performing the non-contact communication with the another apparatus, and

executing an encryption process of data transmitted by the non-contact communication based on a determination of the encryption system determination process.

What is claimed is:

1. An integrated circuit, comprising:
a communication processing section which communicates with another apparatus by non-contact communication capable of executing simultaneous communication by establishing a plurality of connections; and
an encryption processing section which executes an encryption process of data transmitted by the non-contact communication based on encryption information including connections to be encrypted when performing the non-contact communication with the another apparatus.

2. The integrated circuit according to claim 1, further comprising:
an encryption system determination section which determines the connections to be encrypted and an encryption system when performing the non-contact communication with the another apparatus.

3. The integrated circuit according to claim 2,
wherein the encryption system determination section exchanges, with the another apparatus, information of encryption systems which is usable with the another apparatus, prior to a determination of the encryption system to be used when performing the non-contact communication with the another apparatus.

4. The integrated circuit according to claim 2,
wherein the encryption system determination section determines whether to encrypt all the connections or to encrypt a part of the connections.

5. The integrated circuit according to claim 2,
wherein the encryption system determination section is managed in association with information which identifies a value of an encryption key used for encrypted communication with the another apparatus, and the encryption key.

6. The integrated circuit according to claim 2,
wherein each application has an individual service access point, and
wherein the encryption system determination section is managed in association with information which identifies an encryption key used for encrypted communication between the service access point and the another apparatus.

7. The integrated circuit according to claim 6,
wherein when the non-contact communication with the another apparatus ends, the encryption system determination section deletes the association of information which identifies the service access point and the encryption key.

8. The integrated circuit according to claim 6,
wherein after encrypted communication between the service access point and the another apparatus ends, the encryption system determination section reuses a same encryption key in a case where the service access point executes encrypted communication again with a same apparatus.

9. The integrated circuit according to claim 1, further comprising:
an interface for acquiring the encryption information.

10. A communication apparatus, comprising:
a communication processing section which communicates with another apparatus by non-contact communication capable of executing simultaneous communication by establishing a plurality of connections;
an encryption system determination section which determines the connections to be encrypted when performing the non-contact communication with the another apparatus; and
an encryption processing section which executes an encryption process of data transmitted by the non-contact communication based on a determination of the encryption system determination section.

11. A communication method comprising a communication processing process which communicates with another apparatus by non-contact communication capable of executing simultaneous communication by establishing a plurality of connections,
wherein the communication processing process includes
determining the connections to be encrypted when performing the non-contact communication with the another apparatus, and
executing an encryption process of data transmitted by the non-contact communication based on a determination of the encryption system determination process.

12. A computer program for causing a computer to execute a communication processing process which communicates with another apparatus by non-contact communication capable of executing simultaneous communication by establishing a plurality of connections,
wherein the communication processing process includes
determining the connections to be encrypted when performing the non-contact communication with the another apparatus, and
executing an encryption process of data transmitted by the non-contact communication based on a determination of the encryption system determination process.
